(19) United States
(12) Patent Application Publication
(10) Pub. No.: US 2026/0125502 A1
(43) Pub. Date: May 7, 2026

(54) ETHYLENE COPOLYMER COMPOSITION AND FILM APPLICATIONS

(71) Applicant: NOVA Chemicals (International) S.A., Fribourg (CH)

(72) Inventors: Vinod KONAGANTI, Seattle, WA (US); Marcelo YAMANE, Calgary (CA); Marzieh EBRAHIMI, Seattle, WA (US); Fatemeh BAYATI, Calgary (CA)

(73) Assignee: NOVA Chemicals (International) S.A., Fribourg (CH)

(21) Appl. No.: 19/113,585

(22) PCT Filed: Sep. 5, 2023
(86) PCT No.: PCT/IB2023/058775

§ 371 Date: Mar. 20, 2025

Related U.S. Application Data
(60) Provisional application No. 63/409,434, filed on Sep. 23, 2022.

(51) Int. Cl. C08F 210/16; C08F 2/06; C08J 5/18

(52) U.S. Cl. CPC C08F 210/16; C08F 2/06; C08J 5/18; C08J 2323/08

(57) ABSTRACT

The present invention provides an ethylene copolymer composition, which comprises at least two ethylene copolymers and which is suitable for use in a film layer. The invention also relates to film layers and to multilayer film structures comprising such layers. These structures are particularly useful in cling or stretch wrap film applications, to which the invention further relates.

### TECHNICAL FIELD

The present invention relates to an ethylene copolymer composition suitable for use in a film layer. The invention also relates to film layers and multilayer film structures comprising such film layers, which structures are particularly useful in cling or stretch wrap film applications.

### BACKGROUND ART

Ethylene-alpha-olefin copolymers are used in a variety of end-use applications, including wrapping films.

In convention wrapping processes, such as spin or rotary stretch wrapping methods, the plastic film is wound under tension around a package by either rotating the package on a turntable or by winding the film around a stationary package. In these applications, it is generally desirable for the overlapping portions of the film to adhere to each other, thereby self-sealing the wrap without the need for an external adhesive or heat-sealing operation.

Multilayer films for cling or storage-wrap or stretch-wrap films may be produced from various polymers and their blends. Polyethylene resins made with different catalysts, manufacturing technologies and operating conditions provide different molecular characteristics and performance attributes. Such films are used for the containment and protection of various items, as well as the preservation of perishable materials such as food items. For instance, U.S. Pat. Nos. 6,194,062, 5,948,493 and 5,617,707 disclose examples of wrapping films with cling properties.

Multicomponent polyethylene compositions are well known in the art. One method to access multicomponent polyethylene compositions is to use two or more distinct polymerization catalysts in one or more polymerization reactors, which may be configured in series or in parallel. For example, the use of single-site and Ziegler-Natta-type polymerization catalysts in at least two distinct solution polymerization reactors is known, such as in WO 2018/193375, WO 2020/012300 and WO 2021/019370, which disclose ethylene copolymer compositions comprising at least two ethylene copolymers of particular properties which are made in distinct reactors. Typically, the second reactor is run at a higher temperature and produces a copolymer of lower weight average molecular weight than the first reactor (see WO 2020/012300 and WO 2021/019370, for example).

Solution polymerization processes are generally carried out at temperatures above the melting point of the ethylene homopolymer or copolymer product being made. In a typical solution polymerization process, catalyst components, solvent, monomers and hydrogen are fed under pressure to one or more reactors.

For solution phase ethylene polymerization, or ethylene copolymerization, reactor temperatures can range from about 80° C. to about 300° C., while pressures generally range from about 3 MPag to about 45 MPag. The ethylene homopolymer or copolymer produced remains dissolved in the solvent under reactor conditions. The residence time of the solvent in the reactor is relatively short, for example from about 1 second to about 20 minutes. The solution process can be operated under a wide range of process conditions that allow the production of a wide variety of ethylene polymers. Post-reactor, the polymerization reactor is quenched to prevent further polymerization, by adding a catalyst deactivator, and optionally passivated, by adding an acid scavenger. Once deactivated (and optionally passivated), the polymer solution is passed to a polymer recovery operation (a devolatilization system), where the ethylene homopolymer or copolymer is separated from process solvent, unreacted residual ethylene and unreacted optional α-olefin(s).

Regardless of the manner of production, there remains a need to improve the performance of multicomponent polyethylene compositions in film applications.

Commonly used polyethylene resins in the packaging industry are broadly characterized as plastomers, very low density polyethylene (VLDPE), linear low density polyethylene (LLDPE), medium density polyethylene (MDPE), low density polyethylene (LDPE) and high density polyethylene (HDPE). These types of polyethylene resins and their blends are commonly used to manufacture flexible films for different applications including cling or stretch wrap films.

In general, polyethylene resins suffer from poor cling force and therefore special tackifying agents, such as polyisobutylene, ethylene-butene polymers, propylene-ethylene polymers or acrylate copolymers, are used in blend compositions to induce or improve cling and elongational properties of stretch wrap films (see U.S. Pat. No. 4,612,221, for example). However, the use of tackifying agents has several drawbacks, including that they tend to have an adverse effect on the optical properties of the film, enhance surface migration of the additive(s), and they can be expensive and difficult to handle during usage, storage and production (i.e. to process through the equipment, due to die build-up, cleaning, high stickiness).

The present invention has been devised in light of the above considerations.

### SUMMARY OF INVENTION

A first aspect of the invention is an ethylene copolymer composition comprising:
(i) from 2 to 45 weight percent of a first ethylene copolymer having a density of from 0.855 to 0.905 g/cm³, a molecular weight distribution (M_{w}/Mₙ) of from 1.8 to 3.0, and a melt index (I₂) of from 0.1 to 100 g/10 min;
(ii) from 55 to 98 weight percent of a second ethylene copolymer having a density of from 0.900 to 0.940 g/cm³, a molecular weight distribution (M_{w}/Mₙ) of from 1.8 to 3.0, and a melt index (I₂) of from 0.1 to 10 g/10 min; and
(iii) from 0 to 30 weight percent of a third ethylene copolymer having a density of from 0.900 to 0.940 g/cm³, a molecular weight distribution (M_{w}/Mₙ) of from 1.8 to 3.0, and a melt index (I₂) of from 0.1 to 10 g/10 min;
wherein the weight average molecular weight (M_{w}) of the second ethylene copolymer is greater than the M_{w} of the first ethylene copolymer, and the M_{w} of the third ethylene copolymer is greater than the M_{w} of the first ethylene copolymer;
the density of the second ethylene copolymer is greater than the density of the first ethylene copolymer, and the density of the third ethylene copolymer is greater than the density of the first ethylene copolymer; and
the ethylene copolymer composition has a density of from 0.900 to 0.925 g/cm³; a melt index of from 0.5 to 10 g/10 min; and a fraction eluting at below 30° C., having an integrated area of greater than 10% in a CTREF analysis;
wherein the weight percent of the first, second or third ethylene copolymer is defined as the weight of the first, second or third copolymer respectively divided by the weight of the sum of (i) the first ethylene copolymer, (ii) the second ethylene copolymer and (iii) the third ethylene copolymer, multiplied by 100.

Suitably, the ethylene copolymer composition is an ethylene-alpha-olefin copolymer composition.

Surprisingly, it has been found that the use of a first ethylene copolymer of low density and a second ethylene copolymer, which has a higher density and higher weight average molecular weight (M_{w}), can lead to an ethylene copolymer composition having a high proportion of soluble weight fractions. The first ethylene copolymer is, for example, a lower density plastomer or elastomer; and the second ethylene copolymer is, for example, a higher density plastomer or VLDPE or LLDPE or MDPE. The ethylene copolymer composition of the invention has a high proportion of soluble weight fractions (greater than 10%), as derived from the slow CTREF (Crystallizable Temperature Rising Elution Fractionation) analysis, which measures the amount of material that elutes from a column below 30° C. The use of such an ethylene copolymer composition, having a high proportion of soluble weight fractions, either alone or in blend compositions, contributes to excellent cling and elongational properties in cling or stretch or storage wrap films.

This is believed to be due to the presence of high amounts of highly branched low molecular weight fractions in the low density first ethylene copolymer, which fractions contribute to the adhesive or cling properties of the ethylene copolymer composition of the invention. Suitably, the ethylene copolymer composition has normal comonomer distribution. In a film, having such highly branched low molecular weight fractions in combination with less branched high molecular weight fractions in the ethylene copolymer composition helps to migrate the tacky (highly branched and low molecular weight) fractions to the surface of the film under high shear extrusion conditions to improve the cling properties of the film, whilst retaining good optical properties and good processability.

Also, producing such highly branched low molecular weight fractions of first ethylene copolymer in a dual reactor in series solution polymerization process requires optimization and identification of appropriate reactor conditions as described later in the document.

This solution results in highly normal comonomer distribution i.e., high amount of short chain branches in the low molecular weight first ethylene copolymer and less number of short chain branches in the high molecular weight second ethylene copolymer which is contrary to typical approaches in the prior art, in which (as mentioned above) the second reactor produces a copolymer of lower M_{w} than the first reactor. Such prior art approaches generally result in an ethylene copolymer composition having a reversed or partially reversed comonomer distribution, whereas the present invention preferably results in normal or highly normal comonomer distribution.

In some embodiments, the first ethylene copolymer is present in from 10 to 35 weight percent. In some embodiments, the first ethylene copolymer is present in from 20 to 35 weight percent.

In some embodiments, the second ethylene copolymer is present in from 65 to 90 weight percent. In some embodiments, the second ethylene copolymer is present in from 65 to 80 weight percent.

The presence of the third ethylene copolymer is optional. In some embodiments, the third copolymer is present. In some embodiments, the third copolymer is present in from 5 to 30 weight percent. In some embodiments, the third copolymer is present in from 5 to 15 weight percent or from 5 to 10 weight percent. In alternative embodiments, the third ethylene copolymer is absent, i.e. present in 0 weight percent.

In some embodiments, the first ethylene copolymer is present in from 2 to 45 weight percent, the second ethylene copolymer is present in from 55 to 98 weight percent, and the third ethylene copolymer is present in 0 weight percent.

In some embodiments, the first ethylene copolymer is present in from 10 to 35 weight percent, and the second ethylene copolymer is present in from 65 to 90 weight percent. In some embodiments, the first ethylene copolymer is present in from 20 to 35 weight percent, and the second ethylene copolymer is present in from 65 to 80 weight percent.

In some embodiments, the first ethylene copolymer is present in from 10 to 35 weight percent, the second ethylene copolymer is present in from 65 to 90 weight percent, and the third ethylene copolymer is present in 0 weight percent. In some embodiments, the first ethylene copolymer is present in from 20 to 35 weight percent, the second ethylene copolymer is present in from 65 to 80 weight percent, and the third ethylene copolymer is present in 0 weight percent.

The ethylene copolymer composition is an ethylene-alpha-olefin copolymer composition, which comprises one or more than one alpha-olefin comonomer. In some embodiments, the ethylene copolymer composition has at least 0.8 mol percent alpha-olefin comonomer (i.e. one or more than one alpha-olefin comonomer), for example at least 1 mole percent, or at least 2 mole percent, or at least 3 mole percent, or at least 5 mole percent, or at least 10 mole percent. In some embodiments, the ethylene copolymer composition has at most about 25 mole percent alpha-olefin comonomer, for example at most 25 mole percent, or at most 10 mole percent, or at most 8 mole percent, or at most 5 mole percent, or at most 3 mole percent.

In some embodiments, the ethylene copolymer composition has from about 0.8 to about 25 mole percent alpha-olefin comonomer, for example from 0.8 to 25 mole percent, or from about 0.8 to about 8 mole percent, or from about 1 to about 10 mole percent, or from about 1 to about 8 mole percent, or from about 1 to about 5 mole percent, or from about 1 to about 3 mole percent, or from about 2 to about 8 mole percent, or from about 2 to about 5 mole percent, or from about 3 to about 8 mole percent, or from about 5 to about 25 mole percent, or from about 5 to about 10 mole percent, or from about 10 to about 25 mole percent.

In some embodiments, the ethylene copolymer composition has at least 0.8 mol percent C₃ to C₁₀ alpha-olefin comonomer, for example at least 1 mole percent, or at least 2 mole percent, or at least 3 mole percent, or at least 5 mole percent, or at least 10 mole percent. In some embodiments, the ethylene copolymer composition has at most about 25 mole percent C₃ to C₁₀ alpha-olefin comonomer, for example at most 25 mole percent, or at most 10 mole percent, or at most 8 mole percent, or at most 5 mole percent, or at most 3 mole percent.

In some embodiments, the ethylene copolymer composition has from about 0.8 to about 25 mole percent C₃ to C₁₀ alpha-olefin comonomer, for example from 0.8 to 25 mole percent, or from about 0.8 to about 8 mole percent, or from about 1 to about 10 mole percent, or from about 1 to about 8 mole percent, or from about 1 to about 5 mole percent, or from about 1 to about 3 mole percent, or from about 2 to about 8 mole percent, or from about 2 to about 5 mole percent, or from about 3 to about 8 mole percent, or from about 5 to about 25 mole percent, or from about 5 to about 10 mole percent, or from about 10 to about 25 mole percent.

In some embodiments, said alpha-olefin comonomer is selected from the group comprising 1-butene, 1-hexene, 1-octene and mixtures thereof.

In some embodiments, said alpha-olefin comonomer is selected from the group comprising 1-hexene, 1-octene and mixtures thereof. In some embodiments, said alpha-olefin comonomer consists of 1-octene.

In some embodiments, the first ethylene copolymer is made with a single-site catalyst system. In some embodiments, the second ethylene copolymer is made with a Ziegler-Natta catalyst system. In some embodiments, where the third ethylene copolymer is present, the third ethylene copolymer is made with a Ziegler-Natta catalyst system.

In some embodiments, the first ethylene copolymer is made with a single-site catalyst system and the second ethylene copolymer is made with a Ziegler-Natta catalyst system. In some embodiments, the first ethylene copolymer is made with a single-site catalyst system and the third ethylene copolymer is made with a Ziegler-Natta catalyst system. In some embodiments, the second ethylene copolymer is made with a Ziegler-Natta catalyst system and the third ethylene copolymer is made with a Ziegler-Natta catalyst system. In some embodiments, the first ethylene copolymer is made with a single-site catalyst system, the second ethylene copolymer is made with a Ziegler-Natta catalyst system and the third ethylene copolymer is made with a Ziegler-Natta catalyst system.

A second aspect of the invention is a film layer comprising the ethylene copolymer composition as defined in the first aspect.

In some embodiments, the film layer further comprises a linear low density polyethylene (LLDPE).

In some embodiments, the film layer comprises at least 0 weight percent of the LLDPE. In some embodiments, the film layer comprises at least 5 weight percent of the LLDPE, for example at least 10 weight percent, or at least 15 weight percent, or at least 20 weight percent, or at least 25 weight percent, or at least 30 weight percent, or at least 40 weight percent, or at least 50 weight percent.

In some embodiments, the film layer comprises at most 80 weight percent of the LLDPE, for example at most 75 weight percent, or at most 70 weight percent, or at most 65 weight percent, or at most 60 weight percent, or at most 55 weight percent, or at most 50 weight percent, or at most 45 weight percent, or at most 40 weight percent, or at most 30 weight percent.

In some embodiments, the film layer comprises at least 20 weight percent of the ethylene copolymer composition of the first aspect, for example at least 25 weight percent, or at least 30 weight percent, or at least 35 weight percent, or at least 40 weight percent, or at least 45 weight percent, or at least 50 weight percent, or at least 55 weight percent, or at least 60 weight percent, or at least 70 weight percent.

In some embodiments, the film layer comprises at most 100 weight percent of the ethylene copolymer composition of the first aspect. In some embodiments, the film layer comprises at most 95 weight percent of the ethylene copolymer composition of the first aspect, for example at most 90 weight percent, or at most 85 weight percent, or at most 80 weight percent, or at most 75 weight percent, or at most 70 weight percent, or at most 60 weight percent, or at most 50 weight percent.

In some embodiments, the film layer comprises from 20 to 70 weight percent of the LLDPE. In some embodiments, the film layer comprises from 25 to 65 weight percent of the LLDPE. In some embodiments, the film layer comprises from 30 to 60 weight percent of the LLDPE.

In some embodiments, the film layer comprises from 30 to 80 weight percent of the ethylene copolymer composition of the first aspect. In some embodiments, the film layer comprises from 35 to 75 weight percent of the ethylene copolymer composition of the first aspect. In some embodiments, the film layer comprises from 40 to 70 weight percent of the ethylene copolymer composition of the first aspect.

In some embodiments, the film layer comprises from 20 to 70 weight percent of the LLDPE and from 30 to 80 weight percent of the ethylene copolymer composition of the first aspect. In some embodiments, the film layer comprises from 25 to 65 weight percent of the LLDPE and from 35 to 75 weight percent of the ethylene copolymer composition of the first aspect. In some embodiments, the film layer comprises from 30 to 60 weight percent of the LLDPE and from 40 to 70 weight percent of the ethylene copolymer composition of the first aspect.

In these embodiments, the weight percent of the ethylene copolymer composition or the LLDPE is defined as the weight of the ethylene copolymer composition or the LLDPE respectively divided by the weight of the sum of the ethylene copolymer composition and the LLDPE, multiplied by 100.

A third aspect of the invention is a multilayer film structure comprising the film layer as defined in the second aspect. Hence, the third aspect also provides a multilayer film structure comprising the ethylene copolymer composition as defined in the first aspect.

As aforementioned, film structures comprising the ethylene copolymer composition described herein, which have a high proportion of soluble weight fractions, are particularly useful in cling or stretch or storage wrap films, because these film structures exhibit excellent cling and elongational properties, whilst also having good processability and optical properties.

The multilayer film structure comprises multiple layers. These layers may be selected from one or more than one film layer as defined in the second aspect, and one or more other types of layer.

In some embodiments, the film structure comprises at least two layers. In some embodiments, the film structure comprises at least three layers. In some embodiments, the film structure comprises at least four layers. In some embodiments, the film structure comprises at least five layers. In some embodiments, the film structure comprises at least six layers. In some embodiments, the film structure comprises at least seven layers. In some embodiments, the film structure comprises at least eight layers. In some embodiments, the film structure comprises at least nine layers.

In some embodiments, the film structure comprises two layers. In some embodiments, the film structure comprises three layers. In some embodiments, the film structure comprises four layers. In some embodiments, the film structure comprises five layers. In some embodiments, the film structure comprises six layers.

In some embodiments, the film structure comprises seven layers. In some embodiments, the film structure comprises eight layers. In some embodiments, the film structure comprises nine layers.

In some embodiments, the film structure comprises between three and nine layers.

The film layer as defined in the second aspect may be a skin layer in the multilayer structure. The skin layer may be, for example, an outermost or surface layer in the film structure, which layer contacts the item to be wrapped, when the film structure is used in stretch or cling wrap film applications (i.e. the skin layer is the “cling layer”).

In some embodiments, the multilayer film structure comprises two film layers of the second aspect. These two film layers may be skin layers. The two skin layers may be opposite outermost layers in the film structure, which outermost layers may sandwich other layers, which other layers may be one or more further film layers as defined in the second aspect, and/or one or more alternative types of layer. A layer that is sandwiched between two skin layers may be referred to as a “core layer”. Hence, in some embodiments, the multilayer film structure comprises a core layer, which may be between, for example sandwiched between, two skin layers as described herein.

The core layer(s) can be made up of polyethylene copolymer such as linear low density polyethylene or medium density polyethylene or high density polyethylene or non-polyethylene materials such as nylon, ethylene vinyl alcohol, ethylene vinyl acetate etc.

In some embodiments, the film layer as defined in the second aspect may be at least one core layer in the multilayer structure.

In some embodiments, the multilayer film structure comprises at least one film layer of the second aspect. In some embodiments, the multilayer film structure comprises at least two film layers of the second aspect. In some embodiments, the multilayer film structure comprises at least three film layers of the second aspect. In some embodiments, the multilayer film structure comprises at least four film layers of the second aspect.

In some embodiments, the multilayer film structure comprises one, two, three or four film layers of the second aspect.

In some embodiments, the multilayer film structure comprises at least one core layer, for example at least two core layers, at least three core layers, at least four core layers, at least five core layers, at least six core layers, or at least seven core layers.

In some embodiments, the multilayer film structure comprises one, two, three, four, five, six, seven, eight, or nine core layers.

In some embodiments, where there are two skin layers, the skin layers are of approximately equal thickness.

In some embodiments, the multilayer film structure comprises at least one core layer and two skin layers. In some embodiments, the multilayer film structure comprises at least two core layers and two skin layers. In some embodiments, the multilayer film structure comprises at least three core layers and two skin layers. In some embodiments, the multilayer film structure comprises at least five core layers and two skin layers. In some embodiments, the multilayer film structure comprises at least seven core layers and two skin layers.

In some embodiments, the multilayer film structure comprises one core layer and two skin layers. In some embodiments, the multilayer film structure comprises two core layers and two skin layers. In some embodiments, the multilayer film structure comprises three core layers and two skin layers. In some embodiments, the multilayer film structure comprises five core layers and two skin layers. In some embodiments, the multilayer film structure comprises seven core layers and two skin layers. In some embodiments, the multilayer film structure comprises nine core layers and two skin layers.

A fourth aspect of the invention is a cling wrap film or stretch wrap film comprising the multilayer film structure as defined in the third aspect. Hence, the fourth aspect also provides a cling wrap film or stretch wrap film comprising the film layer as defined in the second aspect. Moreover, the fourth aspect also provides a cling wrap film or stretch wrap film comprising the ethylene copolymer composition as defined in the first aspect.

The invention includes the combination of the aspects and preferred features described except where such a combination is clearly impermissible or expressly avoided.

### BRIEF DESCRIPTION OF THE FIGURES

Embodiments and experiments illustrating the principles of the invention will now be discussed with reference to the accompanying figures in which:

FIG. 1 shows a graph in which the density and the soluble fraction (wt %) eluted below 30° C. of the Inventive and Comparative Examples are plotted.

FIG. 2 shows a graph in which the density and the hexane extractables percentage are plotted for the Inventive and Comparative Examples.

FIG. 3 shows GPC-FTIR molecular weight distribution and branch frequency distribution of Inventive Examples 1 to 4.

### DESCRIPTION OF EMBODIMENTS

Aspects and embodiments of the present invention will now be discussed with reference to the accompanying figures. Further aspects and embodiments will be apparent to those skilled in the art. All documents mentioned in this text are incorporated herein by reference.

### Definition of Terms

Other than in the examples or where otherwise indicated, all numbers or expressions referring to quantities of ingredients, extrusion conditions, etc., used in the specification and claims are to be understood as modified in all instances by the term “about”. Accordingly, unless indicated to the contrary, the numerical parameters set forth in the following specification and attached claims are approximations that can vary depending upon the desired properties that the various embodiments desire to obtain. At the very least, and not as an attempt to limit the application of the doctrine of equivalents to the scope of the claims, each numerical parameter should at least be construed in light of the number of reported significant digits and by applying ordinary rounding techniques. The numerical values set forth in the specific examples are reported as precisely as possible. Any numerical values, however, inherently contain certain errors necessarily resulting from the standard deviation found in their respective testing measurements.

It should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

All compositional ranges expressed herein are limited in total to and do not exceed 100 percent (volume percent or weight percent) in practice. Where multiple components can be present in a composition, the sum of the maximum amounts of each component can exceed 100 percent, with the understanding that, and as those skilled in the art readily understand, that the amounts of the components actually used will conform to the maximum of 100 percent.

In order to form a more complete understanding of this disclosure the following terms are defined and should be used with the accompanying figures and the description of the various embodiments throughout.

As used herein, the term “monomer” refers to a small molecule that may chemically react and become chemically bonded with itself or other monomers to form a polymer.

As used herein, the term “α-olefin” or “alpha-olefin” is used to describe a monomer having a linear hydrocarbon chain containing from 3 to 20 carbon atoms having a double bond at one end of the chain; an equivalent term is “linear α-olefin”. As used herein, the term “polyethylene” or “ethylene polymer”, refers to macromolecules produced from ethylene monomers and optionally one or more additional monomers; regardless of the specific catalyst or specific process used to make the ethylene polymer. In the polyethylene art, the one or more additional monomers are called “comonomer(s)” and often include α-olefins. The term “homopolymer” refers to a polymer that contains only one type of monomer. An “ethylene homopolymer” is made using only ethylene as a polymerizable monomer. The term “copolymer” refers to a polymer that contains two or more types of monomer. An “ethylene copolymer” is made using ethylene and one or more other types of polymerizable monomer. Common polyethylenes include high density polyethylene (HDPE), medium density polyethylene (MDPE), linear low density polyethylene (LLDPE), very low density polyethylene (VLDPE), ultra low density polyethylene (ULDPE), plastomer and elastomers. The term polyethylene also includes polyethylene terpolymers which may include two or more comonomers in addition to ethylene. The term polyethylene also includes combinations of, or blends of, the polyethylenes described above.

The term “heterogeneously branched polyethylene” refers to a subset of polymers in the ethylene polymer group that are produced using a heterogeneous catalyst system; non-limiting examples of which include Ziegler-Natta or chromium catalysts, both of which are well known in the art.

The term “homogeneously branched polyethylene” refers to a subset of polymers in the ethylene polymer group that are produced using single-site catalysts; non-limiting examples of which include metallocene catalysts, phosphinimine catalysts, and constrained geometry catalysts all of which are well known in the art.

Typically, homogeneously branched polyethylenes have narrow molecular weight distributions, for example gel permeation chromatography (GPC) M_{w}/Mₙ values of less than about 2.8, especially less than about 2.3, although exceptions may arise; M_{w} and Mₙ refer to weight and number average molecular weights, respectively. In contrast, the M_{w}/Mₙ of heterogeneously branched ethylene polymers are typically greater than the M_{w}/Mₙ of homogeneous polyethylene. In general, homogeneously branched ethylene polymers also have a narrow composition distribution, i.e. each macromolecule within the molecular weight distribution has a similar comonomer content. Frequently, the composition distribution breadth index “CDBI” is used to quantify how the comonomer is distributed within an ethylene polymer, as well as to differentiate ethylene polymers produced with different catalysts or processes. The “CDBI₅₀” is defined as the percent of ethylene polymer whose composition is within 50 weight percent (wt %) of the median comonomer composition; this definition is consistent with that described in WO 93/03093 assigned to Exxon Chemical Patents Inc. The CDBI₅₀ of an ethylene copolymer can be calculated from TREF curves (Temperature Rising Elution Fractionation); the TREF method is described in Wild, et al., J. Polym. Sci., Part B, Polym. Phys., Vol. 20 (3), pages 441-455. Typically the CDBI₅₀ of homogeneously branched ethylene polymers are greater than about 70% or greater than about 75%. In contrast, the CDBI₅₀ of α-olefin-containing heterogeneously branched ethylene polymers are generally lower than the CDBI₅₀ of homogeneous ethylene polymers. For example, the CDBI₅₀ of a heterogeneously branched ethylene polymer may be less than about 75%, or less than about 70%.

It is well known to those skilled in the art, that homogeneously branched ethylene polymers are frequently further subdivided into “linear homogeneous ethylene polymers” and “substantially linear homogeneous ethylene polymers”. These two subgroups differ in the amount of long chain branching: more specifically, linear homogeneous ethylene polymers have less than about 0.01 long chain branches per 1000 carbon atoms; while substantially linear ethylene polymers have greater than about 0.01 to about 3.0 long chain branches per 1000 carbon atoms. A long chain branch is macromolecular in nature, i.e. similar in length to the macromolecule that the long chain branch is attached to. Hereafter, in this disclosure, the term “homogeneously branched polyethylene” or “homogeneously branched ethylene polymer” refers to both linear homogeneous ethylene polymers and substantially linear homogeneous ethylene polymers.

The term “thermoplastic” refers to a polymer that becomes liquid when heated, will flow under pressure and solidify when cooled. Thermoplastic polymers include ethylene polymers as well as other polymers used in the plastic industry; non-limiting examples of other polymers commonly used in film applications include barrier resins (EVOH), tie resins, polyethylene terephthalate (PET), polyamides and the like.

As used herein the term “monolayer film” refers to a film containing a single layer of one or more thermoplastics.

As used herein the term “multilayer film” or “multilayer film structure” refers to a film comprised of more than one thermoplastic layer, or optionally non-thermoplastic layers. Non-limiting examples of non-thermoplastic materials include metals (foil) or cellulosic (paper) products. One or more of the thermoplastic layers within a multilayer film (or film structure) may be comprised of more than one thermoplastic.

As used herein, the term “tie resin” refers to a thermoplastic that when formed into an intermediate layer, or a “tie layer” within a multilayer film structure, promotes adhesion between adjacent film layers that are dissimilar in chemical composition. Thus, a multilayer film structure as described herein may comprise a tie resin.

As used herein, the term “sealant layer” refers to a layer of thermoplastic film that is capable of being attached to a second substrate, forming a leak proof seal. A “sealant layer” may be a skin layer or the innermost layer in a multilayer film structure. Thus, a multilayer film structure as described herein may comprise a sealant layer.

As used herein, the term “adhesive lamination” and the term “extrusion lamination” describes continuous processes through which two or more substrates, or webs of material, are combined to form a multilayer product or sheet; wherein the two or more webs are joined using an adhesive or a molten thermoplastic film, respectively.

As used herein, the term “extrusion coating” describes a continuous process through which a molten thermoplastic layer is combined with, or deposited on, a moving solid web or substrate. Non-limiting examples of substrates include paper, paperboard, foil, monolayer plastic film, multilayer plastic film or fabric. The molten thermoplastic layer could be monolayer or multilayer.

As used herein, the terms “hydrocarbyl”, “hydrocarbyl radical” or “hydrocarbyl group” refers to linear or cyclic, aliphatic, olefinic, acetylenic and aryl (aromatic) radicals comprising hydrogen and carbon that are deficient by one hydrogen.

As used herein, an “alkyl radical” includes linear, branched and cyclic paraffin radicals that are deficient by one hydrogen radical; non-limiting examples include methyl (—CH₃) and ethyl (—CH₂CH₃) radicals. The term “alkenyl radical” refers to linear, branched and cyclic hydrocarbons containing at least one carbon-carbon double bond that is deficient by one hydrogen radical.

As used herein, the term “aryl” group includes phenyl, naphthyl, pyridyl and other radicals whose molecules have an aromatic ring structure; non-limiting examples include naphthylene, phenanthrene and anthracene. An “arylalkyl” group is an alkyl group having an aryl group pendant there from; non-limiting examples include benzyl, phenethyl and tolylmethyl; an “alkylaryl” is an aryl group having one or more alkyl groups pendant there from; non-limiting examples include tolyl, xylyl, mesityl and cumyl.

As used herein, the phrase “heteroatom” includes any atom other than carbon and hydrogen that can be bound to carbon. A “heteroatom-containing group” is a hydrocarbon radical that contains a heteroatom and may contain one or more of the same or different heteroatoms. In some embodiments, a heteroatom-containing group is a hydrocarbyl group containing from 1 to 3 atoms selected from the group consisting of boron, aluminum, silicon, germanium, nitrogen, phosphorous, oxygen and sulfur. Non-limiting examples of heteroatom-containing groups include radicals of imines, amines, oxides, phosphines, ethers, ketones, oxoazolines heterocyclics, oxazolines, thioethers, and the like. The term “heterocyclic” refers to ring systems having a carbon backbone that comprise from 1 to 3 atoms selected from the group consisting of boron, aluminum, silicon, germanium, nitrogen, phosphorous, oxygen and sulfur.

As used herein the term “unsubstituted” means that hydrogen radicals are bounded to the molecular group that follows the term unsubstituted. The term “substituted” means that the group following this term possesses one or more moieties (non-hydrogen radicals) that have replaced one or more hydrogen radicals in any position within the group; non-limiting examples of moieties include halogen radicals (F, Cl, Br), hydroxyl groups, carbonyl groups, carboxyl groups, silyl groups, amine groups, phosphine groups, alkoxy groups, phenyl groups, naphthyl groups, C₁ to C₃₀ alkyl groups, C₂ to C₃₀ alkenyl groups, and combinations thereof. Non-limiting examples of substituted alkyls and aryls include: acyl radicals, alkyl silyl radicals, alkylamino radicals, alkoxy radicals, aryloxy radicals, alkylthio radicals, dialkylamino radicals, alkoxycarbonyl radicals, aryloxycarbonyl radicals, carbomoyl radicals, alkyl- and dialkyl-carbamoyl radicals, acyloxy radicals, acylamino radicals, arylamino radicals and combinations thereof.

In the present disclosure, an ethylene copolymer composition will comprise a first ethylene copolymer having a density, d1; a second ethylene copolymer having a density, d2; and optionally a third ethylene copolymer having a density, d3; wherein the density of the second ethylene copolymer is greater than the density of the first ethylene copolymer. Each of these ethylene copolymer components and the ethylene copolymer composition of which they are a part are further described below.

### The First Ethylene Copolymer

In some embodiments, alpha-olefins which may be copolymerized with ethylene to make the first ethylene copolymer may be selected from the group comprising 1-propene, 1-butene, 1-pentene, 1-hexene and 1-octene and mixtures thereof.

In some embodiments, the first ethylene copolymer is an ethylene/1-octene copolymer.

In some embodiments, the first ethylene copolymer is a homogeneously branched ethylene copolymer.

In some embodiments, the first ethylene copolymer is made with a single site catalyst, non-limiting examples of which include phosphinimine catalysts, metallocene catalysts, and constrained geometry catalysts, all of which are well known in the art.

In some embodiments, the first ethylene copolymer is made with a single site catalyst system comprising a metallocene catalyst.

In some embodiments, the first ethylene copolymer is made with a single site catalyst, having hafnium, Hf, as the active metal center (i.e. the catalyst is a hafnocene catalyst).

In some embodiments, the first ethylene copolymer is made with a metallocene catalyst.

In some embodiments, the first ethylene copolymer is made with a bridged metallocene catalyst.

In some embodiments, the first ethylene copolymer is made with a bridged metallocene catalyst having the Formula (I):

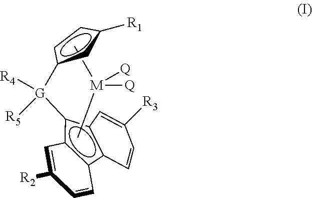

In Formula (I): M is a group 4 metal selected from titanium, zirconium or hafnium; G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In some embodiments, R₄ and R₅ are independently an aryl group.

In some embodiments, R₄ and R₅ are independently a phenyl group or a substituted phenyl group.

In some embodiments, R₄ and R₅ are a phenyl group.

In some embodiments, R₄ and R₅ are independently a substituted phenyl group.

In some embodiments, R₄ and R₅ are a substituted phenyl group, wherein the phenyl group is substituted with a substituted silyl group.

In some embodiments, R₄ and R₅ are a substituted phenyl group, wherein the phenyl group is substituted with a trialkyl silyl group.

In some embodiments, R₄ and R₅ are a substituted phenyl group, wherein the phenyl group is substituted at the para position with a trialkylsilyl group. In some embodiments, R¹ and R² are a substituted phenyl group, wherein the phenyl group is substituted at the para position with a trimethylsilyl group. In some embodiments, R¹ and R² are a substituted phenyl group, wherein the phenyl group is substituted at the para position with a triethylsilyl group.

In some embodiments, R₄ and R₅ are independently an alkyl group.

In some embodiments, R₄ and R₅ are independently an alkenyl group.

In some embodiments, R₁ is hydrogen.

In some embodiments, R₁ is an alkyl group.

In some embodiments, R₁ is an aryl group.

In some embodiments, R₁ is an alkenyl group.

In some embodiments, R₂ and R₃ are independently a hydrocarbyl group having from 1 to 30 carbon atoms.

In some embodiments, R₂ and R₃ are independently an aryl group.

In some embodiments, R₂ and R₃ are independently an alkyl group.

In some embodiments, R₂ and R₃ are independently an alkyl group having from 1 to 20 carbon atoms.

In some embodiments, R₂ and R₃ are independently a phenyl group or a substituted phenyl group.

In some embodiments, R₂ and R₃ are a tert-butyl group.

In some embodiments, R₂ and R₃ are hydrogen.

In some embodiments, M is hafnium, Hf.

In some embodiments, the first ethylene copolymer is made with a bridged metallocene catalyst having the Formula (I):

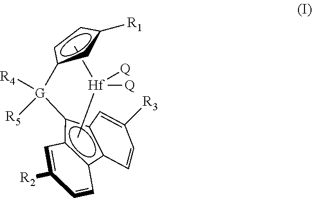

In Formula (I): G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In the current disclosure, the term “activatable”, means that the ligand Q may be cleaved from the metal center M via a protonolysis reaction or abstracted from the metal center M by suitable acidic or electrophilic catalyst activator compounds (also known as “co-catalyst” compounds) respectively, examples of which are described below. The activatable ligand Q may also be transformed into another ligand which is cleaved or abstracted from the metal center M (e.g. a halide may be converted to an alkyl group). Without wishing to be bound by any single theory, protonolysis or abstraction reactions generate an active “cationic” metal center which can polymerize olefins.

In some embodiments, the activatable ligand, Q is independently selected from the group consisting of a hydrogen atom; a halogen atom; a C₁₋₂₀ hydrocarbyl radical, a C₁₋₂₀ alkoxy radical, and a C₆₋₁₀ aryl or aryloxy radical, where each of the hydrocarbyl, alkoxy, aryl, or aryl oxide radicals may be un-substituted or further substituted by one or more halogen or other group; a C₁₋₈ alkyl; a C₁₋₈ alkoxy; a C₆₋₁₀ aryl or aryloxy; an amido or a phosphido radical, but where Q is not a cyclopentadienyl. Two Q ligands may also be joined to one another and form for example, a substituted or unsubstituted diene ligand (e.g. 1,3-butadiene); or a delocalized heteroatom containing group such as an acetate or acetamidinate group. In a convenient embodiment of the disclosure, each Q is independently selected from the group consisting of a halide atom, a C₁₋₄ alkyl radical and a benzyl radical. Particularly suitable activatable ligands Q are monoanionic such as a halide (e.g. chloride) or a hydrocarbyl (e.g. methyl, benzyl).

In some embodiments, the single site catalyst used to make the first ethylene copolymer is diphenylmethylene(cyclopentadienyl)(2,7-di-t-butylfluorenyl)hafnium dichloride having the molecular formula: [(2,7-tBu₂Flu)Ph₂C(Cp)HfCl₂]. In some embodiments, the single site catalyst used to make the first ethylene copolymer is diphenylmethylene(cyclopentadienyl)(2,7-di-t-butylfluorenyl)hafnium dimethyl having the molecular formula: [(2,7-tBu₂Flu)Ph₂C(Cp)HfMe_{2].}

In addition to the single site catalyst molecule per se, an active single site catalyst system may further comprise one or more of the following: an alkylaluminoxane co-catalyst and an ionic activator. The single site catalyst system may also optionally comprise a hindered phenol.

Although the exact structure of alkylaluminoxane is uncertain, subject matter experts generally agree that it is an oligomeric species that contain repeating units of the general formula:

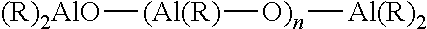

where the R groups may be the same or different linear, branched or cyclic hydrocarbyl radicals containing 1 to 20 carbon atoms and n is from 0 to about 50. A non-limiting example of an alkylaluminoxane is methylaluminoxane (or MAO) wherein each R group is a methyl radical.

In some embodiments, R of the alkylaluminoxane, is a methyl radical and m is from 10 to 40.

In some embodiments, the co-catalyst is modified methylaluminoxane (MMAO).

It is well known in the art, that the alkylaluminoxane can serve dual roles as both an alkylator and an activator. Hence, an alkylaluminoxane co-catalyst is often used in combination with activatable ligands such as halogens.

In general, ionic activators are comprised of a cation and a bulky anion; wherein the latter is substantially non-coordinating. Non-limiting examples of ionic activators are boron ionic activators that are four coordinate with four ligands bonded to the boron atom. Non-limiting examples of boron ionic activators include the following formulas shown below:

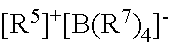

where B represents a boron atom, R⁵ is an aromatic hydrocarbyl (e.g. triphenyl methyl cation) and each R⁷ is independently selected from phenyl radicals which are unsubstituted or substituted with from 3 to 5 substituents selected from fluorine atoms, C₁₋₄ alkyl or alkoxy radicals which are unsubstituted or substituted by fluorine atoms; and a silyl radical of formula —Si(R⁹)₃, where each R⁹ is independently selected from hydrogen atoms and C₁₋₄ alkyl radicals, and

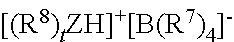

where B is a boron atom, H is a hydrogen atom, Z is a nitrogen or phosphorus atom, t is 2 or 3 and R⁸ is selected from C₁₋₈ alkyl radicals, phenyl radicals which are unsubstituted or substituted by up to three C₁₋₄ alkyl radicals, or one R⁸ taken together with the nitrogen atom may form an anilinium radical and R⁷ is as defined above.

In both formulae, a non-limiting example of R⁷ is a pentafluorophenyl radical. In general, boron ionic activators may be described as salts of tetra(perfluorophenyl) boron; non-limiting examples include anilinium, carbonium, oxonium, phosphonium and sulfonium salts of tetra(perfluorophenyl)boron with anilinium and trityl (or triphenylmethylium). Additional non-limiting examples of ionic activators include: triethylammonium tetra(phenyl)boron, tripropylammonium tetra(phenyl)boron, tri(n-butyl)ammonium tetra(phenyl)boron, trimethylammonium tetra(p-tolyl)boron, trimethylammonium tetra(o-tolyl)boron, tributylammonium tetra(pentafluorophenyl)boron, tripropylammonium tetra(o,p-dimethylphenyl)boron, tributylammonium tetra(m,m-dimethylphenyl)boron, tributylammonium tetra(p-trifluoromethylphenyl)boron, tributylammonium tetra(pentafluorophenyl)boron, tri(n-butyl)ammonium tetra(o-tolyl)boron, N,N-dimethylanilinium tetra(phenyl)boron, N,N-diethylanilinium tetra(phenyl)boron, N,N-diethylanilinium tetra(phenyl)n-butylboron, N,N-2,4,6-pentamethylanilinium tetra(phenyl)boron, di-(isopropyl)ammonium tetra(pentafluorophenyl)boron, dicyclohexylammonium tetra(phenyl)boron, triphenylphosphonium tetra(phenyl)boron, tri(methylphenyl)phosphonium tetra(phenyl)boron, tri(dimethylphenyl)phosphonium tetra(phenyl)boron, tropillium tetrakispentafluorophenyl borate, triphenylmethylium tetrakispentafluorophenyl borate, benzene(diazonium)tetrakispentafluorophenyl borate, tropillium tetrakis(2,3,5,6-tetrafluorophenyl)borate, triphenylmethylium tetrakis(2,3,5,6-tetrafluorophenyl)borate, benzene(diazonium) tetrakis(3,4,5-trifluorophenyl)borate, tropillium tetrakis(3,4,5-trifluorophenyl)borate, benzene(diazonium) tetrakis(3,4,5-trifluorophenyl)borate, tropillium tetrakis(1,2,2-trifluoroethenyl)borate, triphenylmethylium tetrakis(1,2,2-trifluoroethenyl)borate, benzene(diazonium) tetrakis(1,2,2-trifluoroethenyl)borate, tropillium tetrakis(2,3,4,5-tetrafluorophenyl)borate, triphenylmethylium tetrakis(2,3,4,5-tetrafluorophenyl)borate, and benzene(diazonium) tetrakis(2,3,4,5 tetrafluorophenyl)borate. Readily available commercial ionic activators include N,N-dimethylanilinium tetrakispentafluorophenyl borate, and triphenylmethylium tetrakispentafluorophenyl borate.

Non-limiting examples of hindered phenols include butylated phenolic antioxidants, butylated hydroxytoluene, 2,6-di-tertiarybutyl-4-ethyl phenol, 4,4′-methylenebis (2,6-di-tertiary-butylphenol), 1,3, 5-trimethyl-2,4,6-tris (3,5-di-tert-butyl-4-hydroxybenzyl) benzene and octadecyl-3-(3′,5′-di-tert-butyl-4′-hydroxyphenyl) propionate.

To produce an active single site catalyst system, the quantity and mole ratios of the three or four components: the single site catalyst, the alkylaluminoxane, the ionic activator, and the optional hindered phenol are optimized.

In some embodiments, the single site catalyst used to make the first ethylene copolymer produces no long chain branches, and/or the first ethylene copolymer will contain no measurable amounts of long chain branches.

In some embodiments, the single site catalyst used to make the first ethylene copolymer produces long chain branches, and the first ethylene copolymer will contain long chain branches, hereinafter “LCB”. LCB is a well-known structural phenomenon in ethylene copolymers and well known to those of ordinary skill in the art. Traditionally, there are three methods for LCB analysis, namely, nuclear magnetic resonance spectroscopy (NMR), for example see J. C. Randall, J Macromol. Sci., Rev. Macromol. Chem. Phys. 1989, 29, 201; triple detection SEC equipped with a DRI, a viscometer and a low-angle laser light scattering detector, for example see W. W. Yau and D. R. Hill, Int. J. Polym. Anal. Charact. 1996; 2:151; and rheology, for example see W. W. Graessley, Acc. Chem. Res. 1977, 10, 332-339. In this disclosure, a long chain branch is macromolecular in nature, i.e. long enough to be seen in an NMR spectra, triple detector SEC experiments or rheological experiments.

In some embodiments, the first ethylene copolymer contains long chain branching characterized by the LCBF disclosed herein. In embodiments of the disclosure, the upper limit on the LCBF of the first ethylene copolymer may be about 0.5, in other cases about 0.4 and in still other cases about 0.3 (dimensionless). In embodiments of the disclosure, the lower limit on the LCBF of the first ethylene copolymer may be about 0.001, in other cases about 0.0015 and in still other cases about 0.002 (dimensionless).

In some embodiments, the LCBF of the first ethylene copolymer is from 0.001 to 0.5, or from 0.0015 to 0.5, or from 0.002 to 0.5, or from 0.001 to 0.4, or from 0.0015 to 0.4, or from 0.002 to 0.4, or from 0.001 to 0.3, or from 0.0015 to 0.3, or from 0.002 to 0.3.

The first ethylene copolymer may contain catalyst residues that reflect the chemical composition of the catalyst formulation used to make it. Those skilled in the art will understand that catalyst residues are typically quantified by the parts per million by weight of metal, in for example the first ethylene copolymer (or the ethylene copolymer composition; see below), where the metal present originates from the metal in the catalyst formulation used to make it. Non-limiting examples of the metal residue which may be present include Group 4 metals, titanium, zirconium and hafnium. In embodiments of the disclosure, the upper limit on the ppm of metal in the first ethylene copolymer may be about 3.0 ppm, in other cases about 2.0 ppm and in still other cases about 1.5 ppm. In embodiments of the disclosure, the lower limit on the ppm of metal in the first ethylene copolymer may be about 0.03 ppm, in other cases about 0.09 ppm and in still other cases about 0.15 ppm.

In some embodiments, the first ethylene copolymer has from 0.03 to 3.0 ppm of metal, or from 0.09 to 3.0 ppm of metal, or from 0.15 to 3.0 ppm of metal, or from 0.03 to 2.0 ppm of metal, or from 0.09 to 2.0 ppm of metal, or from 0.15 to 2.0 ppm of metal, from 0.03 to 1.5 ppm of metal, or from 0.09 to 1.5 ppm of metal, or from 0.15 to 1.5 ppm of metal.

In some embodiments, the first ethylene copolymer has a density of from 0.855 to 0.905 g/cm³, a molecular weight distribution (M_{w}/Mₙ) of from 1.8 to 3.0, and a melt index (I₂) of from 0.1 to 100 g/10 min.

In some embodiments, the upper limit of the molecular weight distribution (M_{w}/Mₙ) of the first ethylene copolymer is about 3.0, or about 2.8, or about 2.6, or about 2.4, or about 2.2. In some embodiments, the lower limit of the molecular weight distribution (M_{w}/Mₙ) of the first ethylene copolymer is about 1.8, or about 1.9, or about 2.0, or about 2.1.

In some embodiments, the first ethylene copolymer has a molecular weight distribution (M_{w}/Mₙ) of ≤3.0, or <3.0, or ≤2.8, or <2.8, or ≤2.6, or <2.6, or ≤2.4, or <2.4, or ≤2.2, or <2.2. In some embodiments, the first ethylene copolymer has a molecular weight distribution (M_{w}/Mₙ) of from about 1.8 to about 3.0, or from about 1.9 to about 2.8, or from about 2.0 to about 2.4.

In some embodiments, the first ethylene copolymer has from 10 to 150 short chain branches per thousand carbon atoms (SCB1). In further embodiments, the first ethylene copolymer has from 10 to 120 short chain branches per thousand carbon atoms (SCB1), or from 10 to 100 short chain branches per thousand carbon atoms (SCB1), or from 15 to 100 short chain branches per thousand carbon atoms (SCB1), or from 15 to 80 short chain branches per thousand carbon atoms (SCB1), or from 20 to 80 short chain branches per thousand carbon atoms (SCB1), or from 25 to 80 short chain branches per thousand carbon atoms (SCB1). In still further embodiments, the first ethylene copolymer has from 15 to 70 short chain branches per thousand carbon atoms (SCB1), or from 20 to 70 short chain branches per thousand carbon atoms (SCB1), or from 25 to 70 short chain branches per thousand carbon atoms (SCB1), or from 30 to 70 short chain branches per thousand carbon atoms (SCB1), or from 35 to 70 short chain branches per thousand carbon atoms (SCB1), or from 35 to 60 short chain branches per thousand carbon atoms (SCB1), or from 40 to 60 short chain branches per thousand carbon atoms (SCB1).

The short chain branching (i.e. the short chain branching per thousand backbone carbon atoms, SCB) is the branching due to the presence of an alpha-olefin comonomer in the ethylene copolymer and will for example have two carbon atoms for a 1-butene comonomer, or four carbon atoms for a 1-hexene comonomer, or six carbon atoms for a 1-octene comonomer, etc.

In some embodiments, the number of short chain branches per thousand carbon atoms in the first ethylene copolymer (SCB1), is greater than the number of short chain branches per thousand carbon atoms in the second ethylene copolymer (SCB2).

In some embodiments, the number of short chain branches per thousand carbon atoms in the first ethylene copolymer (SCB1), is greater than the number of short chain branches per thousand carbon atoms in the third ethylene copolymer (SCB3).

In some embodiments, the number of short chain branches per thousand carbon atoms in the first ethylene copolymer (SCB1), is greater than the number of short chain branches per thousand carbon atoms in each of the second ethylene copolymer (SCB2) and the third ethylene copolymer (SCB3).

In embodiments of the disclosure, the upper limit on the density (d1) of the first ethylene copolymer may be about 0.905 g/cm³, in some cases about 0.902 g/cm³, in other cases about 0.899 g/cm³, in still other cases about 0.896 g/cm³, in yet still other cases about 0.893 g/cm³, or about 0.890 g/cm³, or about 0.887 g/cm³, or about 0.884 g/cm³. In embodiments of the disclosure, the lower limit on the density (d1) of the first ethylene copolymer may be about 0.855 g/cm³, in some cases about 0.860 g/cm³, in some cases about 0.865 g/cm³, and in other cases about 0.870 g/cm³.

In embodiments of the disclosure, the density (d1) of the first ethylene copolymer may be from about 0.855 g/cm³ to about 0.905 g/cm³, or from about 0.855 g/cm³ to about 0.902 g/cm³, or from about 0.855 g/cm³ to about 0.899 g/cm³, or from about 0.855 g/cm³ to about 0.896 g/cm³, or from about 0.855 g/cm³ to about 0.893 g/cm³, or from about 0.855 g/cm³ to about 0.890 g/cm³, or from about 0.855 g/cm³ to about 0.887 g/cm³, or from about 0.855 g/cm³ to about 0.884 g/cm³, or from about 0.860 g/cm³ to about 0.905 g/cm³, or from about 0.860 g/cm³ to about 0.902 g/cm³, or from about 0.860 g/cm³ to about 0.899 g/cm³, or from about 0.860 g/cm³ to about 0.896 g/cm³, or from about 0.860 g/cm³ to about 0.893 g/cm³, or from about 0.860 g/cm³ to about 0.890 g/cm³, or from about 0.860 g/cm³ to about 0.887 g/cm³, or from about 0.860 g/cm³ to about 0.884 g/cm³, or from about 0.865 g/cm³ to about 0.905 g/cm³, or from about 0.865 g/cm³ to about 0.902 g/cm³, or from about 0.865 g/cm³ to about 0.899 g/cm³, or from about 0.865 g/cm³ to about 0.896 g/cm³, or from about 0.865 g/cm³ to about 0.893 g/cm³, or from about 0.865 g/cm³ to about 0.890 g/cm³, or from about 0.865 g/cm³ to about 0.887 g/cm³, or from about 0.865 g/cm³ to about 0.884 g/cm³, or from about 0.870 g/cm³ to about 0.905 g/cm³, or from about 0.870 g/cm³ to about 0.902 g/cm³, or from about 0.870 g/cm³ to about 0.899 g/cm³, or from about 0.870 g/cm³ to about 0.896 g/cm³, or from about 0.870 g/cm³ to about 0.893 g/cm³, or from about 0.870 g/cm³ to about 0.890 g/cm³, or from about 0.870 g/cm³ to about 0.887 g/cm³, or from about 0.870 g/cm³ to about 0.884 g/cm³.

In some embodiments, the density of the first ethylene copolymer (d1) is less than the density of the second ethylene copolymer (d2).

In embodiments of the disclosure, the upper limit on the CDBI₅₀ of the first ethylene copolymer may be about 98 weight %, in other cases about 95 wt % and in still other cases about 90 wt %. In embodiments of the disclosure, the lower limit on the CDBI₅₀ of the first ethylene copolymer may be about 70 weight percent, in other cases about 75 wt % and in still other cases about 80 wt %. In some embodiments, the first ethylene copolymer has a CDBI₅₀ of at least 75 wt %.

In embodiments of the disclosure, the melt index of the first ethylene copolymer (I₂¹) may be from about 0.1 g/10 min to about 100 g/10 min, or from about 0.1 g/10 min to about 75 g/10 min, or from about 1 g/10 min to about 100 g/10 min, or from about 1 g/10 min to about 75 g/10 min, or from about 0.1 g/10 min to about 50 g/10 min, or from about 4 g/10 min to about 75 g/10 min, or from about 4 g/10 min to about 50 g/10 min, or from about 4 g/10 min to about 25 g/10 min, or from about 8 g/10 min to about 50 g/10 min, or from about 8 g/10 min to about 25 g/10 min, or less than about 75 g/10 min, or less than about 50 g/10 min, or less than about 25 g/10 min.

In some embodiments, the first ethylene copolymer has a weight average molecular weight (M_{w}) of from about 20,000 to about 200,000, or from about 20,000 to about 150,000, or from about 20,000 to about 100,000, or from about 20,000 to about 75,000, or from about 30,000 to about 100,000, or from about 30,000 to about 75,000; or from about 40,000 to about 100,000, or from about 40,000 to about 75,000.

In some embodiments, the first ethylene copolymer has a weight average molecular weight (M_{w}) which is less than the weight average molecular weight (M_{w}) of the second ethylene copolymer.

In some embodiments, the upper limit on the weight percent (wt %) of the first ethylene copolymer in the ethylene copolymer composition (i.e. the weight percent of the first ethylene copolymer based on the total weight of the first, the second and the third ethylene copolymer) is about 45 wt %, or about 42 wt %, or about 39 wt %, or about 37 wt %, or about 35 wt %, or about 33 wt %, or about 31 wt %. In some embodiments, the lower limit on the wt % of the first ethylene copolymer in the ethylene copolymer composition is about 2 wt %, or about 10 wt %, or about 20 wt %, or about 23 wt %, or about 26 wt %, or about 29 wt %.

### The Second Ethylene Copolymer

In some embodiments, the second ethylene copolymer is made with a multi-site catalyst system, non-limiting examples of which include Ziegler-Natta catalysts and chromium catalysts, both of which are well known in the art.

In embodiments of the disclosure, alpha-olefins which may be copolymerized with ethylene to make the second ethylene copolymer may be selected from the group comprising 1-propene, 1-butene, 1-pentene, 1-hexene and 1-octene and mixtures thereof.

In some embodiments, the second ethylene copolymer is a heterogeneously branched ethylene copolymer.

In some embodiments, the second ethylene copolymer is an ethylene/1-octene copolymer.

In some embodiments, the second ethylene copolymer is made with a Ziegler-Natta catalyst system.

Ziegler-Natta catalyst systems are well known to those skilled in the art. A Ziegler-Natta catalyst may be an in-line Ziegler-Natta catalyst system or a batch Ziegler-Natta catalyst system. The term “in-line Ziegler-Natta catalyst system” refers to the continuous synthesis of a small quantity of an active Ziegler-Natta catalyst system and immediately injecting this catalyst into at least one continuously operating reactor, wherein the catalyst polymerizes ethylene and one or more optional α-olefins to form an ethylene polymer. The terms “batch Ziegler-Natta catalyst system” or “batch Ziegler-Natta procatalyst” refer to the synthesis of a much larger quantity of catalyst or procatalyst in one or more mixing vessels that are external to, or isolated from, the continuously operating solution polymerization process. Once prepared, the batch Ziegler-Natta catalyst system, or batch Ziegler-Natta procatalyst, is transferred to a catalyst storage tank. The term “procatalyst” refers to an inactive catalyst system (inactive with respect to ethylene polymerization); the procatalyst is converted into an active catalyst by adding an alkyl aluminum co-catalyst. As needed, the procatalyst is pumped from the storage tank to at least one continuously operating reactor, wherein an active catalyst polymerizes ethylene and one or more optional α-olefins to form an ethylene copolymer. The procatalyst may be converted into an active catalyst in the reactor or external to the reactor, or on route to the reactor.

A wide variety of compounds can be used to synthesize an active Ziegler-Natta catalyst system. The following describes various compounds that may be combined to produce an active Ziegler-Natta catalyst system. Those skilled in the art will understand that the embodiments in this disclosure are not limited to the specific compounds disclosed.

An active Ziegler-Natta catalyst system may be formed from: a magnesium compound, a chloride compound, a metal compound, an alkyl aluminum co-catalyst and an aluminum alkyl. As will be appreciated by those skilled in the art, Ziegler-Natta catalyst systems may contain additional components; a non-limiting example of an additional component is an electron donor, e.g. amines or ethers.

A non-limiting example of an active in-line (or batch) Ziegler-Natta catalyst system can be prepared as follows. In the first step, a solution of a magnesium compound is reacted with a solution of a chloride compound to form a magnesium chloride support suspended in solution. Non-limiting examples of magnesium compounds include Mg(R¹)₂; wherein the R¹ groups may be the same or different, linear, branched or cyclic hydrocarbyl radicals containing 1 to 10 carbon atoms. Non-limiting examples of chloride compounds include R²Cl; wherein R² represents a hydrogen atom, or a linear, branched or cyclic hydrocarbyl radical containing 1 to 10 carbon atoms. In the first step, the solution of magnesium compound may also contain an aluminum alkyl. Non-limiting examples of aluminum alkyl include Al(R³)₃, wherein the R³ groups may be the same or different, linear, branched or cyclic hydrocarbyl radicals containing from 1 to 10 carbon atoms. In the second step a solution of the metal compound is added to the solution of magnesium chloride and the metal compound is supported on the magnesium chloride. Non-limiting examples of suitable metal compounds include M(X)ₙ or MO(X)ₙ; where M represents a metal selected from Group 4 through Group 8 of the Periodic Table, or mixtures of metals selected from Group 4 through Group 8; O represents oxygen; and X represents chloride or bromide; n is an integer from 3 to 6 that satisfies the oxidation state of the metal. Additional non-limiting examples of suitable metal compounds include Group 4 to Group 8 metal alkyls, metal alkoxides (which may be prepared by reacting a metal alkyl with an alcohol) and mixed-ligand metal compounds that contain a mixture of halide, alkyl and alkoxide ligands. In the third step a solution of an alkyl aluminum co-catalyst is added to the metal compound supported on the magnesium chloride. A wide variety of alkyl aluminum co-catalysts are suitable, as expressed by formula:

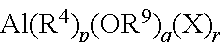

wherein the R⁴ groups may be the same or different, hydrocarbyl groups having from 1 to 10 carbon atoms; the OR⁹ groups may be the same or different, alkoxy or aryloxy groups wherein R⁹ is a hydrocarbyl group having from 1 to 10 carbon atoms bonded to oxygen; X is chloride or bromide; and (p+q+r)=3, with the proviso that p is greater than 0. Non-limiting examples of commonly used alkyl aluminum co-catalysts include trimethyl aluminum, triethyl aluminum, tributyl aluminum, dimethyl aluminum methoxide, diethyl aluminum ethoxide, dibutyl aluminum butoxide, dimethyl aluminum chloride or bromide, diethyl aluminum chloride or bromide, dibutyl aluminum chloride or bromide and ethyl aluminum dichloride or dibromide.

The process described in the paragraph above, to synthesize an active in-line (or batch) Ziegler-Natta catalyst system, can be carried out in a variety of solvents; non-limiting examples of solvents include linear or branched C₅ to C₁₂ alkanes or mixtures thereof.

In some embodiments, the second ethylene copolymer has a density of from 0.900 to 0.940 g/cm³, a molecular weight distribution (M_{w}/Mₙ) of from 1.8 to 4.0, and a melt index (I₂) of from 0.1 to 10 g/10 min.

In some embodiments, the second ethylene copolymer has a molecular weight distribution (M_{w}/Mₙ) of ≥1.8, or >1.8, or ≥2.1, or >2.1, or ≥2.4, or >2.4, or ≥2.7, or >2.7, or ≥3.0, or >3.0. In some embodiments, the second ethylene copolymer has a molecular weight distribution (M_{w}/Mₙ) of from 1.8 to 4.0, or from 2.1 to 4.0, or from 2.4 to 4.0, or from 2.7 to 4.0, or from 3.0 to 4.0, or from 3.2 to 4.0, or from 1.8 to 3.8, or from 2.1 to 3.8, or from 2.4 to 3.8, or from 2.7 to 3.8, or from 3.0 to 3.8, or from 3.2 to 3.8, or from 1.8 to 3.6, or from 2.1 to 3.6, or from 2.4 to 3.6, or from 2.7 to 3.6, or from 3.0 to 3.6, or from 3.2 to 3.6, or from 1.8 to 3.4, or from 2.1 to 3.4, or from 2.4 to 3.4, or from 2.7 to 3.4, or from 3.0 to 3.4, or from 3.2 to 3.4.

In some embodiments, the second ethylene copolymer has from 1 to 100 short chain branches per thousand carbon atoms (SCB2). In further embodiments, the second ethylene copolymer has from 1 to 50 short chain branches per thousand carbon atoms (SCB2), or from 1 to 30 short chain branches per thousand carbon atoms (SCB2), or from 1 to 25 short chain branches per thousand carbon atoms (SCB2), or from 3 to 50 short chain branches per thousand carbon atoms (SCB2), or from 5 to 50 short chain branches per thousand carbon atoms (SCB2), or from 5 to 30 short chain branches per thousand carbon atoms (SCB2). In still further embodiments, the second ethylene copolymer has from 3 to 30 short chain branches per thousand carbon atoms (SCB2), or from 3 to 25 short chain branches per thousand carbon atoms (SCB2), or from 5 to 25 short chain branches per thousand carbon atoms (SCB2), or from 3 to 20 short chain branches per thousand carbon atoms (SCB2), or from 5 to 20 short chain branches per thousand carbon atoms (SCB2), or from 3 to 15 short chain branches per thousand carbon atoms (SCB2), or from 5 to 15 short chain branches per thousand carbon atoms (SCB2).

The short chain branching (i.e. the short chain branching per thousand backbone carbon atoms, SCB) is the branching due to the presence of an alpha-olefin comonomer in the ethylene copolymer and will for example have two carbon atoms for a 1-butene comonomer, or four carbon atoms for a 1-hexene comonomer, or six carbon atoms for a 1-octene comonomer, etc.

In some embodiments, the upper limit on the density (d2) of the second ethylene copolymer is about 0.940 g/cm³, in some cases about 0.936 g/cm³, in some cases about 0.932 g/cm³, and in other cases about 0.928 g/cm³. In some embodiments, the lower limit on the density (d2) of the second ethylene copolymer is about 0.900 g/cm³, in some cases about 0.905 g/cm³, in some cases about 0.910 g/cm³, and in other cases about 0.914 g/cm³.

In embodiments of the disclosure, the density (d2) of the second ethylene copolymer may be from about 0.900 g/cm³ to about 0.940 g/cm³, or from about 0.900 g/cm³ to about 0.936 g/cm³, or from about 0.900 g/cm³ to about 0.932 g/cm³, or from about 0.900 g/cm³ to about 0.928 g/cm³, or from about 0.905 g/cm³ to about 0.940 g/cm³, or from about 0.905 g/cm³ to about 0.936 g/cm³, or from about 0.905 g/cm³ to about 0.932 g/cm³, or from about 0.905 g/cm³ to about 0.928 g/cm³, or from about 0.910 g/cm³ to about 0.940 g/cm³, or from about 0.910 g/cm³ to about 0.936 g/cm³, or from about 0.910 g/cm³ to about 0.932 g/cm³, or from about 0.910 g/cm³ to about 0.928 g/cm³, or from about 0.914 g/cm³ to about 0.940 g/cm³, or from about 0.914 g/cm³ to about 0.936 g/cm³, or from about 0.914 g/cm³ to about 0.932 g/cm³, or from about 0.914 g/cm³ to about 0.928 g/cm³.

In some embodiments, the density of the second ethylene copolymer (d2) is greater than the density of the first ethylene copolymer (d1).

In some embodiments, the second ethylene copolymer has a composition distribution breadth index (CDBI₅₀) of less than 75 weight percent or 70 weight percent or less. In further embodiments, the second ethylene copolymer has a CDBI₁₅ of 65 wt % or less, or 60 wt % or less, or 55 wt % or less, or 50 wt % or less, or 45 wt % or less.

In embodiments of the disclosure, the melt index of the second ethylene copolymer (I₂²) may be from about 0.1 g/10 min to about 10 g/10 min, or from about 0.2 g/10 min to about 10 g/10 min, or from about 1 g/10 min to about 10 g/10 min, or from about 2 g/10 min to about 10 g/10 min, or from about 0.1 g/10 min to about 8 g/10 min, or from about 0.2 g/10 min to about 8 g/10 min, or from about 1 g/10 min to about 8 g/10 min, or from about 2 g/10 min to about 8 g/10 min, or from about 0.1 g/10 min to about 6 g/10 min, or from about 0.2 g/10 min to about 6 g/10 min, or from about 1 g/10 min to about 6 g/10 min, or from about 2 g/10 min to about 6 g/10 min.

In some embodiments, the second ethylene copolymer has a weight average molecular weight (M_{w}) of from about 25,000 to about 250,000, or from about 25,000 to about 200,000, or from about 30,000 to about 150,000, or from about 40,000 to about 150,000, or from about 50,000 to about 130,000, or from about 50,000 to about 110,000.

In some embodiments, the second ethylene copolymer has a weight average molecular weight (M_{w}) which is greater than the weight average molecular weight (M_{w}) of the first ethylene copolymer.

In some embodiments, the upper limit on the weight percent (wt %) of the second ethylene copolymer in the ethylene copolymer composition (i.e. the weight percent of the second ethylene copolymer based on the total weight of the first, the second and the third copolymer) is about 98 wt %, or about 95 wt %, or about 90 wt %, or about 85 wt %, or about 80 wt %. In some embodiments, the lower limit on the wt % of the second ethylene copolymer in the ethylene copolymer composition is about 55 wt %, or about 60 wt %, or about 63 wt %, or about 66 wt %, or about 69 wt %.

In some embodiments, the second ethylene copolymer has no long chain branching present or does not have any detectable levels of long chain branching.

### The Third Ethylene Copolymer

In some embodiments, the third ethylene copolymer is made with a single site catalyst, non-limiting examples of which include phosphinimine catalysts, metallocene catalysts, and constrained geometry catalysts, all of which are well known in the art.

In some embodiments, the third ethylene copolymer is made with a multi-site catalyst, non-limiting examples of which include Ziegler-Natta catalysts and chromium catalysts, both of which are well known in the art.

In embodiments of the disclosure, alpha-olefins which may be copolymerized with ethylene to make the third ethylene copolymer may be selected from the group comprising 1-propene, 1-butene, 1-pentene, 1-hexene and 1-octene and mixtures thereof.

In some embodiments, the third ethylene copolymer is a homogeneously branched ethylene copolymer.

In some embodiments, the third ethylene copolymer is an ethylene/1-octene copolymer.

In some embodiments, the third ethylene copolymer is made with a metallocene catalyst.

In some embodiments, the third ethylene copolymer is made with a Ziegler-Natta catalyst system.

In some embodiments, the third ethylene copolymer is a heterogeneously branched ethylene copolymer.

In some embodiments, the third ethylene copolymer has no long chain branching present or does not have any detectable levels of long chain branching.

In some embodiments, the third ethylene copolymer will contain long chain branches, hereinafter “LCB”. LCB is a well-known structural phenomenon in ethylene copolymers and well known to those of ordinary skill in the art. Traditionally, there are three methods for LCB analysis, namely, nuclear magnetic resonance spectroscopy (NMR), for example see J. C. Randall, J Macromol. Sci., Rev. Macromol. Chem. Phys. 1989, 29, 201; triple detection SEC equipped with a DRI, a viscometer and a low-angle laser light scattering detector, for example see W. W. Yau and D. R. Hill, Int. J. Polym. Anal. Charact. 1996; 2:151; and rheology, for example see W. W. Graessley, Acc. Chem. Res. 1977, 10, 332-339. In this disclosure, a long chain branch is macromolecular in nature, i.e. long enough to be seen in an NMR spectra, triple detector SEC experiments or rheological experiments.

In some embodiments, the third ethylene copolymer contains long chain branching characterized by the LCBF disclosed herein. In embodiments of the disclosure, the upper limit on the LCBF of the third ethylene copolymer may be about 0.5, in other cases about 0.4 and in still other cases about 0.3 (dimensionless). In some embodiments, the lower limit on the LCBF of the third ethylene copolymer may be about 0.001, in other cases about 0.0015 and in still other cases about 0.002 (dimensionless).

In some embodiments, the LCBF of the third ethylene copolymer is from 0.001 to 0.5, or from 0.0015 to 0.5, or from 0.002 to 0.5, or from 0.001 to 0.4, or from 0.0015 to 0.4, or from 0.002 to 0.4, or from 0.001 to 0.3, or from 0.0015 to 0.3, or from 0.002 to 0.3.

In some embodiments, the third ethylene copolymer has a density of from 0.900 to 0.940 g/cm³, a molecular weight distribution (M_{w}/Mₙ) of from 1.8 to 4.0, and a melt index (I₂) of from 0.1 to 10 g/10 min.

In some embodiments, the third ethylene copolymer has a molecular weight distribution (M_{w}/Mₙ) of ≥1.8, or ≥1.8, or ≥2.1, or >2.1, or ≥2.4, or >2.4, or ≥2.7, or >2.7, or ≥3.0, or >3.0. In some embodiments, the third ethylene copolymer has a molecular weight distribution (M_{w}/Mₙ) of from 1.8 to 4.0, or from 2.1 to 4.0, or from 2.4 to 4.0, or from 2.7 to 4.0, or from 3.0 to 4.0, or from 3.2 to 4.0, or from 1.8 to 3.8, or from 2.1 to 3.8, or from 2.4 to 3.8, or from 2.7 to 3.8, or from 3.0 to 3.8, or from 3.2 to 3.8, or from 1.8 to 3.6, or from 2.1 to 3.6, or from 2.4 to 3.6, or from 2.7 to 3.6, or from 3.0 to 3.6, or from 3.2 to 3.6, or from 1.8 to 3.4, or from 2.1 to 3.4, or from 2.4 to 3.4, or from 2.7 to 3.4, or from 3.0 to 3.4, or from 3.2 to 3.4.

In some embodiments, the third ethylene copolymer has from 1 to 100 short chain branches per thousand carbon atoms (SCB3). In further embodiments, the third ethylene copolymer has from 1 to 50 short chain branches per thousand carbon atoms (SCB3), or from 1 to 30 short chain branches per thousand carbon atoms (SCB3), or from 1 to 25 short chain branches per thousand carbon atoms (SCB3), or from 3 to 50 short chain branches per thousand carbon atoms (SCB3), or from 5 to 50 short chain branches per thousand carbon atoms (SCB3), or from 5 to 30 short chain branches per thousand carbon atoms (SCB3). In still further embodiments, the third ethylene copolymer has from 3 to 30 short chain branches per thousand carbon atoms (SCB3), or from 3 to 25 short chain branches per thousand carbon atoms (SCB3), or from 5 to 25 short chain branches per thousand carbon atoms (SCB3), or from 3 to 20 short chain branches per thousand carbon atoms (SCB3), or from 5 to 20 short chain branches per thousand carbon atoms (SCB3), or from 3 to 15 short chain branches per thousand carbon atoms (SCB3), or from 5 to 15 short chain branches per thousand carbon atoms (SCB3).

The short chain branching (i.e. the short chain branching per thousand backbone carbon atoms, SCB) is the branching due to the presence of an alpha-olefin comonomer in the ethylene copolymer and will for example have two carbon atoms for a 1-butene comonomer, or four carbon atoms for a 1-hexene comonomer, or six carbon atoms for a 1-octene comonomer, etc.

In some embodiments, the upper limit on the density (d3) of the third ethylene copolymer is about 0.940 g/cm³, in some cases about 0.936 g/cm³, in some cases about 0.932 g/cm³, and in other cases about 0.928 g/cm³. In some embodiments, the lower limit on the density (d2) of the third ethylene copolymer is about 0.900 g/cm³, in some cases about 0.905 g/cm³, in some cases about 0.910 g/cm³, and in other cases about 0.914 g/cm³.

In embodiments of the disclosure, the density (d3) of the third ethylene copolymer may be from about 0.900 g/cm³ to about 0.940 g/cm³, or from about 0.900 g/cm³ to about 0.936 g/cm³, or from about 0.900 g/cm³ to about 0.932 g/cm³, or from about 0.900 g/cm³ to about 0.928 g/cm³, or from about 0.905 g/cm³ to about 0.940 g/cm³, or from about 0.905 g/cm³ to about 0.936 g/cm³, or from about 0.905 g/cm³ to about 0.932 g/cm³, or from about 0.905 g/cm³ to about 0.928 g/cm³, or from about 0.910 g/cm³ to about 0.940 g/cm³, or from about 0.910 g/cm³ to about 0.936 g/cm³, or from about 0.910 g/cm³ to about 0.932 g/cm³, or from about 0.910 g/cm³ to about 0.928 g/cm³, or from about 0.914 g/cm³ to about 0.940 g/cm³, or from about 0.914 g/cm³ to about 0.936 g/cm³, or from about 0.914 g/cm³ to about 0.932 g/cm³, or from about 0.914 g/cm³ to about 0.928 g/cm³.

In some embodiments, the density of the third ethylene copolymer (d3) is greater than the density of the first ethylene copolymer (d1).

In some embodiments, the third ethylene copolymer has a composition distribution breadth index (CDBI₅₀) of less than 75 weight percent or 70 weight percent or less. In further embodiments, the third ethylene copolymer has a CDBI₅₀ of 65 wt % or less, or 60 wt % or less, or 55 wt % or less, or 50 wt % or less, or 45 wt % or less.

In embodiments of the disclosure, the melt index of the third ethylene copolymer (I₂³) may be from about 0.1 g/10 min to about 10 g/10 min, or from about 0.2 g/10 min to about 10 g/10 min, or from about 1 g/10 min to about 10 g/10 min, or from about 2 g/10 min to about 10 g/10 min, or from about 0.1 g/10 min to about 8 g/10 min, or from about 0.2 g/10 min to about 8 g/10 min, or from about 1 g/10 min to about 8 g/10 min, or from about 2 g/10 min to about 8 g/10 min, or from about 0.1 g/10 min to about 6 g/10 min, or from about 0.2 g/10 min to about 6 g/10 min, or from about 1 g/10 min to about 6 g/10 min, or from about 2 g/10 min to about 6 g/10 min.

In some embodiments, the third ethylene copolymer has a weight average molecular weight (M_{w}) of from about 25,000 to about 250,000, or from about 25,000 to about 200,000, or from about 30,000 to about 150,000, or from about 40,000 to about 150,000, or from about 50,000 to about 130,000, or from about 50,000 to about 110,000.

In some embodiments, the third ethylene copolymer has a weight average molecular weight (M_{w}) which is greater than the weight average molecular weight (M_{w}) of the first ethylene copolymer.

In some embodiments, the upper limit on the weight percent (wt %) of the third ethylene copolymer in the ethylene copolymer composition (i.e. the weight percent of the second ethylene copolymer based on the total weight of the first, the second and the third copolymer) is about 30 wt %, or about 25 wt %, or about 20 wt %, or about 15 wt %, or about 10 wt %. In some embodiments, the lower limit on the wt % of the third ethylene copolymer in the ethylene copolymer composition is about 0 wt %, or about 5 wt %, or about 10 wt %, or about 15 wt %, or about 20 wt %.

### The Ethylene Copolymer Composition

The polyethylene compositions disclosed herein can be made using any well-known techniques in the art, including but not limited to melt blending, solution blending, or in-reactor blending to bring together a first ethylene copolymer, a second ethylene copolymer and optionally a third ethylene copolymer.

In some embodiments, the ethylene copolymer composition of the present disclosure is made using a single site catalyst in a first reactor to give a first ethylene copolymer, and a multi-site catalyst is used in a second reactor to give a second ethylene copolymer.

In some embodiments, the ethylene copolymer composition of the present disclosure is made using a single site catalyst in a first reactor to give a first ethylene copolymer, a multi-site catalyst is used in a second reactor to give a second ethylene copolymer, and a multi-site catalyst is used in a third reactor to give a third ethylene copolymer.

In some embodiments, the ethylene copolymer composition of the present disclosure is made using a single site catalyst in a first reactor to give a first ethylene copolymer, a multi-site catalyst is used in a second reactor to give a second ethylene copolymer, and a single site catalyst is used in a third reactor to give a third ethylene copolymer.

In some embodiments, the ethylene copolymer composition of the present disclosure is made by forming a first ethylene copolymer in a first reactor by polymerizing ethylene and an alpha-olefin with a single site catalyst; and forming a second ethylene copolymer in a second reactor by polymerizing ethylene and an alpha-olefin with a multi-site catalyst.

In some embodiments, the ethylene copolymer composition of the present disclosure is made by forming a first ethylene copolymer in a first reactor by polymerizing ethylene and an alpha-olefin with a single site catalyst; forming a second ethylene copolymer in a second reactor by polymerizing ethylene and an alpha-olefin with a multi-site catalyst, and forming a third ethylene copolymer in a third reactor by polymerizing ethylene and an alpha olefin with a multi-site catalyst.

In some embodiments, the ethylene copolymer composition of the present disclosure is made by forming a first ethylene copolymer in a first reactor by polymerizing ethylene and an alpha olefin with a single site catalyst; forming a second ethylene copolymer in a second reactor by polymerizing ethylene and an alpha olefin with a multi-site catalyst, and forming a third ethylene copolymer in a third reactor by polymerizing ethylene and an alpha olefin with a single site catalyst.

In some embodiments, the ethylene copolymer composition of the present disclosure is made by forming a first ethylene copolymer in a first solution phase polymerization reactor by polymerizing ethylene and an alpha olefin with a single site catalyst; and forming a second ethylene copolymer in a second solution phase polymerization reactor by polymerizing ethylene and an alpha olefin with a multi-site catalyst.

In some embodiments, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a multi-site catalyst.

In some embodiments, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a single site catalyst.

In some embodiments, the ethylene copolymer composition of the present disclosure is made by forming a first ethylene copolymer in a first solution phase polymerization reactor by polymerizing ethylene and an alpha olefin with a single site catalyst; and forming a second ethylene copolymer in a second solution phase polymerization reactor by polymerizing ethylene and an alpha olefin with a multi-site catalyst, where the first and second solution phase polymerization reactors are configured in series with one another.

In some embodiments, the ethylene copolymer composition of the present disclosure is made by forming a first ethylene copolymer in a first solution phase polymerization reactor by polymerizing ethylene and an alpha olefin with a single site catalyst; and forming a second ethylene copolymer in a second solution phase polymerization reactor by polymerizing ethylene and an alpha olefin with a multi-site catalyst, where the first and second solution phase polymerization reactors are configured in parallel with one another.

In some embodiments, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a multi-site catalyst, where the first and second solution phase polymerization reactors are configured in series with one another.

In some embodiments, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a multi-site catalyst, where at least the first and second solution phase polymerization reactors are configured in series with one another.

In some embodiments, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a multi-site catalyst, where the first, second and third solution phase polymerization reactors are configured in series with one another.

In some embodiments, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a multi-site catalyst, where each of the first, second and third solution phase polymerization reactors are configured in parallel to one another.

In some embodiments, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a multi-site catalyst, where the first and second solution phase reactors are configured in series to one another, and the third solution phase reactor is configured in parallel to the first and second reactors.

In some embodiments, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a single site catalyst, where at least the first and second solution phase polymerization reactors are configured in series with one another.

In some embodiments, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a single site catalyst, where the first, second and third solution phase polymerization reactors are configured in series with one another.

In some embodiments, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a single site catalyst, where each of the first, second and third solution phase polymerization reactors are configured in parallel to one another.

In some embodiments, the ethylene copolymer composition of the present disclosure is made by forming a first ethylene copolymer in a first solution phase polymerization reactor by polymerizing ethylene and an alpha olefin with a single site catalyst; forming a second ethylene copolymer in a second solution phase polymerization reactor by polymerizing ethylene and an alpha olefin with a multi-site catalyst, and forming a third ethylene copolymer in a third solution phase polymerization reactor by polymerizing ethylene and an alpha olefin with a single site catalyst, where the first and second solution phase reactors are configured in series to one another, and the third solution phase reactor is configured in parallel to the first and second reactors.

In some embodiments, one or more of the first, second or third solution phase polymerization reactor is a continuously stirred tank reactor or a tubular reactor.

In some embodiments, one or more of the first, second or third solution phase polymerization reactor is a continuously stirred tank reactor.

In some embodiments, one or more of the first, second or third solution phase polymerization reactor is a tubular reactor.

In some embodiments, the first and second solution phase polymerization reactors are continuously stirred tank reactors, and the third solution phase polymerization reactor is a tubular reactor.

Thus, in some embodiments, the ethylene copolymer composition is made in a solution polymerization process. In solution polymerization, the monomers are dissolved/dispersed in the solvent either prior to being fed to the reactor (or for gaseous monomers the monomer may be fed to the reactor so that it will dissolve in the reaction mixture). Prior to mixing, the solvent and monomers are generally purified to remove potential catalyst poisons such as water, oxygen or metal impurities. The feedstock purification follows standard practices in the art, e.g. molecular sieves, alumina beds and oxygen removal catalysts are used for the purification of monomers. The solvent itself as well (e.g. methyl pentane, cyclohexane, hexane or toluene) is preferably treated in a similar manner.

The feedstock may be heated or cooled prior to feeding to the reactor. Generally, the catalyst components may be premixed in the solvent for the reaction or fed as separate streams to the reactor. In some instances, premixing it may be desirable to provide a reaction time for the catalyst components prior to entering the reaction. Such an “in line mixing” technique is described in a number of patents in the name of DuPont Canada Inc. (e.g. U.S. Pat. No. 5,589,555 issued Dec. 31, 1996).

Solution polymerization processes for the polymerization or copolymerization of ethylene are well known in the art (see for example U.S. Pat. Nos. 6,372,864 and 6,777,509). These processes are conducted in the presence of an inert hydrocarbon solvent. In a solution phase polymerization reactor, a variety of solvents may be used as the process solvent; non-limiting examples include linear, branched or cyclic C₅ to C₁₂ alkanes. Non-limiting examples of α-olefins include 1-propene, 1-butene, 1-pentene, 1-hexene and 1-octene. Suitable catalyst component solvents include aliphatic and aromatic hydrocarbons. Non-limiting examples of aliphatic catalyst component solvents include linear, branched or cyclic C₅₋₁₂ aliphatic hydrocarbons, e.g. pentane, methyl pentane, hexane, heptane, octane, cyclohexane, cyclopentane, methylcyclohexane, hydrogenated naphtha or combinations thereof. Non-limiting examples of aromatic catalyst component solvents include benzene, toluene (methylbenzene), ethylbenzene, o-xylene (1,2-dimethylbenzene), m-xylene (1,3-dimethylbenzene), p-xylene (1,4-dimethylbenzene), mixtures of xylene isomers, hemellitene (1,2,3-trimethylbenzene), pseudocumene (1,2,4-trimethylbenzene), mesitylene (1,3,5-trimethylbenzene), mixtures of trimethylbenzene isomers, prehenitene (1,2,3,4-tetramethylbenzene), durene (1,2,3,5-tetramethylbenzene), mixtures of tetramethylbenzene isomers, pentamethylbenzene, hexamethylbenzene and combinations thereof.

The polymerization temperature in a conventional solution process may be from about 80° C. to about 300° C. In some embodiments, the polymerization temperature in a solution process is from about 120° C. to about 250° C. The polymerization pressure in a solution process may be a “medium pressure process”, meaning that the pressure in the reactor is less than about 6,000 psi (about 42,000 kiloPascals or kPa). In some embodiments, the polymerization pressure in a solution process may be from about 10,000 to about 40,000 kPa, or from about 14,000 to about 22,000 kPa (i.e. from about 2,000 psi to about 3,000 psi).

Suitable monomers for copolymerization with ethylene include C₃₋₂₀ mono- and di-olefins. Preferred comonomers include C₃₋₁₂ alpha olefins which are unsubstituted or substituted by up to two C₁₋₆ alkyl radicals, C₈₋₁₂ vinyl aromatic monomers which are unsubstituted or substituted by up to two substituents selected from the group consisting of C₁₋₄ alkyl radicals, C₄₋₁₂ straight chained or cyclic diolefins which are unsubstituted or substituted by a C₁₋₄ alkyl radical. Illustrative non-limiting examples of such alpha-olefins are one or more of propylene, 1-butene, 1-pentene, 1-hexene, 1-octene and 1-decene, styrene, alpha methyl styrene, and the constrained-ring cyclic olefins such as cyclobutene, cyclopentene, dicyclopentadiene norbornene, alkyl-substituted norbornenes, alkenyl-substituted norbornenes and the like (e.g. 5-methylene-2-norbornene and 5-ethylidene-2-norbornene, bicyclo-(2,2,1)-hepta-2,5-diene).

In some embodiments, the ethylene copolymer composition has at least 1 mole percent of one or more than one alpha-olefin.

In some embodiments, the ethylene copolymer composition has at least 3 mole percent of one or more than one alpha-olefin.

In some embodiments, the ethylene copolymer composition has at least 5 mole percent of one or more than one alpha-olefin.

In some embodiments, the ethylene copolymer composition has from about 1 to about 10 mole percent of one or more than one alpha-olefin.

In some embodiments, the ethylene copolymer composition has from about 3 to about 10 mole percent of one or more than one alpha-olefin.

In some embodiments, the ethylene copolymer composition has from about 3 to about 8 mole percent of one or more than one alpha-olefin.

In some embodiments, the ethylene copolymer composition has from about 5 to about 25 mole percent of one or more than one alpha-olefin.

In some embodiments, the ethylene copolymer composition comprises ethylene and one or more than one alpha-olefin selected from the group comprising 1-butene, 1-hexene, 1-octene and mixtures thereof.

In some embodiments, the ethylene copolymer composition comprises ethylene and one or more than one alpha-olefin selected from the group comprising 1-hexene, 1-octene and mixtures thereof.

In some embodiments, the ethylene copolymer composition comprises ethylene and 1-octene.

In some embodiments, the ethylene copolymer composition comprises ethylene and at least 1 mole percent 1-octene.

In some embodiments, the ethylene copolymer composition comprises ethylene and from 1 to 10 mole percent of 1-octene.

In some embodiments, the ethylene copolymer composition comprises ethylene and from 3 to 8 mole percent of 1-octene.

In some embodiments, the ethylene copolymer composition comprises ethylene and from 5 to 25 mole percent of 1-octene.

In some embodiments, the ethylene copolymer composition has a density which is from about 0.900 g/cm³ to about 0.925 g/cm³, or from about 0.900 g/cm³ to about 0.920 g/cm³, or from about 0.900 g/cm³ to about 0.916 g/cm³, or from about 0.903 g/cm³ to about 0.925 g/cm³, or from about 0.903 g/cm³ to about 0.920 g/cm³, or from about 0.903 g/cm³ to about 0.916 g/cm³, or from about 0.906 g/cm³ to about 0.925 g/cm³, or from about 0.906 g/cm³ to about 0.920 g/cm³, or from about 0.906 g/cm³ to about 0.916 g/cm³.

In some embodiments, the melt index (I₂) of the ethylene copolymer composition is from about 0.5 g/10 min to about 10 g/10 min, or from about 1 g/10 min to about 10 g/10 min, or from about 2 g/10 min to about 10 g/10 min, or from about 3 g/10 min to about 10 g/10 min, or from about 0.5 g/10 min to about 8 g/10 min, or from about 1 g/10 min to about 8 g/10 min, or from about 2 g/10 min to about 8 g/10 min, or from about 3 g/10 min to about 8 g/10 min, or from about 0.5 g/10 min to about 5 g/10 min, or from about 1 g/10 min to about 5 g/10 min, or from about 2 g/10 min to about 5 g/10 min, or from about 3 g/10 min to about 5 g/10 min, or less than about 10 g/10 min, or less than about 8 g/10 min, or less than about 5 g/10 min.

In some embodiments, the high load melt index (I₂₁) of the ethylene copolymer composition may be from about 10 g/10 min to about 10,000 g/10 min, or from about 10 g/10 min to about 1000 g/10 min, or from about 10 g/10 min to about 500 g/10 min, or from about 10 g/10 min to about 250 g/10 min, or from about 10 g/10 min to about 150 g/10 min, or from about 40 g/10 min to about 150 g/10 min, or from about 60 g/10 min to about 150 g/10 min.

In some embodiments, the melt flow ratio (121/12) of the ethylene copolymer composition may be from about 15 to about 1,000, or from about 15 to about 100, or from about 15 to about 80, or from about 15 to about 60, or from about 15 to about 40, or from about 22 to about 80, or from about 22 to about 60, or from about 22 to about 40, or from about 25 to about 80, or from about 25 to about 60, or from about 25 to about 40, or from about 25 to about 35. In some embodiments, the melt flow ratio (121/12) of the ethylene copolymer composition is from 22 to 60.

In some embodiments, the melt flow ratio (121/12) of the ethylene copolymer composition may be less than about 80, or less than about 60, or less than about 40, or less than about 35.

In some embodiments, the ethylene copolymer composition has a weight average molecular weight (M_{w}) of from about 40,000 to about 300,000, or from about 40,000 to about 250,000, or from about 50,000 to about 250,000, or from about 50,000 to about 225,000, or from about 50,000 to about 200,000, or from about 50,000 to about 175,000, or from about 50,000 to about 150,000, or from about 50,000 to about 125,000.

In some embodiments, the ethylene copolymer composition has a lower limit molecular weight distribution (M_{w}/Mₙ) of 2.0, or 2.2, or 2.4, or 2.5. In embodiments of the disclosure, the ethylene copolymer composition has an upper limit molecular weight distribution (M_{w}/Mₙ) of 4.0, or 3.9, or 3.8, or 3.7, or 3.6.

In some embodiments, the ethylene copolymer composition has a molecular weight distribution (M_{w}/Mₙ) of from 2.0 to 4.0, or from 2.0 to 3.9, or from 2.0 to 3.8, or from 2.0 to 3.7, or from 2.0 to 3.6, or from 2.2 to 4.0, or from 2.2 to 3.9, or from 2.2 to 3.8, or from 2.2 to 3.7, or from 2.2 to 3.6, or from 2.4 to 4.0, or from 2.4 to 3.9, or from 2.4 to 3.8, or from 2.4 to 3.7, or from 2.4 to 3.6, or from 2.5 to 4.0, or from 2.5 to 3.9, or from 2.5 to 3.8, or from 2.5 to 3.7, or from 2.5 to 3.6. In some embodiments, the ethylene copolymer composition has a molecular weight distribution (M_{w}/Mₙ) of from 2.0 to 4.0.

In some embodiments, the ethylene copolymer composition has a Z-average molecular weight distribution (M_{z}/M_{w}) of ≤6.0, or <6.0, or ≤5.5, or <5.5, or ≤5.0, or <5.0, or ≤4.5, or <4.5, or ≤4.0, or <4.0. In some embodiments, the ethylene copolymer composition has a Z-average molecular weight distribution (M_{z}/M_{w}) of from 1.5 to 6.0, or from 1.5 to 5.5, or from 1.75 to 5.5, or from 1.75 to 5.0, or from 1.75 to 4.5, or from 1.75 to 4.0, or from 2.0 to 4.5, or from 2.0 to 4.0.

In some embodiments, the ethylene copolymer composition has a unimodal profile in a gel permeation chromatograph generated according to the method of ASTM D6474-99. The term “unimodal” is herein defined to mean there will be only one significant peak or maximum evident in the GPC-curve. A unimodal profile includes a broad unimodal profile. In contrast, the use of the term “bimodal” is meant to convey that in addition to a first peak, there will be a secondary peak or shoulder which represents a higher or lower molecular weight component (i.e. the molecular weight distribution, can be said to have two maxima in a molecular weight distribution curve). Alternatively, the term “bimodal” connotes the presence of two maxima in a molecular weight distribution curve generated according to the method of ASTM D6474-99. The term “multi-modal” denotes the presence of two or more, typically more than two, maxima in a molecular weight distribution curve generated according to the method of ASTM D6474-99.

In some embodiments, the ethylene copolymer composition will have a reverse or partially reverse comonomer distribution profile as measured using GPC-FTIR. If the comonomer incorporation decreases with molecular weight, as measured using GPC-FTIR, the distribution is described as “normal”. If the comonomer incorporation is approximately constant with molecular weight, as measured using GPC-FTIR, the comonomer distribution is described as “flat” or “uniform”. The terms “reverse comonomer distribution” and “partially reverse comonomer distribution” mean that in the GPC-FTIR data obtained for a copolymer, there is one or more higher molecular weight components having a higher comonomer incorporation than in one or more lower molecular weight components. The term “reverse(d) comonomer distribution” is used herein to mean, that across the molecular weight range of an ethylene copolymer, comonomer contents for the various polymer fractions are not substantially uniform and the higher molecular weight fractions thereof have proportionally higher comonomer contents (i.e. if the comonomer incorporation rises with molecular weight, the distribution is described as “reverse” or “reversed”). Where the comonomer incorporation rises with increasing molecular weight and then declines, the comonomer distribution is still considered “reverse”, but may also be described as “partially reverse”. A partially reverse comonomer distribution will exhibit a peak or maximum.

In preferred embodiments, the ethylene copolymer composition has a normal comonomer distribution profile as measured using GPC-FTIR.

In some embodiments, the ethylene copolymer composition has a fraction eluting at below 30° C., having an integrated area of greater than 10 weight percent, in a temperature rising elution fractionation (TREF) analysis as obtained using a CTREF instrument (a “CRYSTAF/Temperature Rising Elution Fractionation” instrument). In some embodiments, the ethylene copolymer composition has a fraction eluting at below 30° C., having an integrated area of greater than 15 weight percent, in a temperature rising elution fractionation (TREF) analysis as obtained using a CTREF instrument (a “CRYSTAF/Temperature Rising Elution Fractionation” instrument). In some embodiments, the ethylene copolymer composition has a fraction eluting at below 30° C., having an integrated area of greater than 20 weight percent, in a temperature rising elution fractionation (TREF) analysis as obtained using a CTREF instrument (a “CRYSTAF/Temperature Rising Elution Fractionation” instrument). In some embodiments, the ethylene copolymer composition has a fraction eluting at below 30° C., having an integrated area of greater than 25 weight percent, in a temperature rising elution fractionation (TREF) analysis as obtained using a CTREF instrument (a “CRYSTAF/Temperature Rising Elution Fractionation” instrument).

In some embodiments, the ethylene copolymer composition has a CDBI₅₀ of from about 40 to 85 weight percent, or from about 45 to 85 wt %, or from about 50 to about 85 wt %, or from about 45 to about 80 wt %, or from about 50 to about 80 wt %, or from about 50 to about 75 wt %, or from about 50 to about 70 wt %. In some embodiments, the ethylene copolymer composition has a CDBI₅₀ of from 50 to 75 weight percent.

In some embodiments, the upper limit on the parts per million by weight (ppm) of hafnium in the ethylene copolymer composition is about 3.0 ppm, or about 2.5 ppm, or about 2.0 ppm, or about 1.5 ppm, or about 1.0 ppm, or about 0.75 ppm, or about 0.5 ppm. In some embodiments, the ethylene copolymer composition has at most 2.5 ppm of hafnium.

In some embodiments, the lower limit on the parts per million by weight (ppm) of hafnium in the ethylene copolymer composition is about 0.0015 ppm, or about 0.0050 ppm, or about 0.0075 ppm, or about 0.010 ppm, or about 0.015 ppm, or about 0.030 ppm, or about 0.050 ppm, or about 0.075 ppm, or about 0.100 ppm, or about 0.150 ppm, or about 0.175 ppm, or about 0.200 ppm. In some embodiments, the ethylene copolymer composition has at least 0.050 ppm of hafnium.

In some embodiments, the ethylene copolymer composition has from 0.0015 to 2.5 ppm of hafnium, or from 0.0050 to 2.5 ppm of hafnium, or from 0.0075 to 2.5 ppm of hafnium, or from 0.010 to 2.5 ppm of hafnium, or from 0.015 to 2.5 ppm of hafnium, or from 0.050 to 3.0 ppm of hafnium, or from 0.050 to 2.5 ppm, or from 0.075 to 2.5 ppm of hafnium, or from 0.075 to 2.0 ppm of hafnium, or from 0.075 to 1.5 ppm of hafnium, or from 0.075 to 1.0 ppm of hafnium, or from 0.075 to 0.5 ppm of hafnium, or from 0.100 to 2.0 ppm of hafnium, or from 0.100 to 1.5 ppm of hafnium, or from 0.100 to 1.0 ppm of hafnium, or from 0.100 to 0.75 ppm of hafnium, or from 0.10 to 0.5 ppm of hafnium, or from 0.15 to 0.5 ppm of hafnium, or from 0.20 to 0.5 ppm of hafnium. In some embodiments, the ethylene copolymer composition has from 0.050 ppm to 2.5 ppm of hafnium.

In some embodiments, the upper limit on the parts per million by weight (ppm) of titanium in the ethylene copolymer composition is about 18.0 ppm, or about 16.0 ppm, or about 14.0 ppm, or about 12.0 ppm, or about 10.0 ppm, or about 8.0 ppm. In some embodiments, the lower limit on the parts per million by weight (ppm) of titanium in the ethylene copolymer composition is about 0.050 ppm, or about 0.1 ppm, or about 0.5 ppm, or about 1.0 ppm, or about 2.0 ppm, or about 3.0 ppm.

In some embodiments, the ethylene copolymer composition has from 0.050 to 14.0 ppm of titanium, or from 0.5 to 20.0 ppm of titanium, or from 0.5 to 18.0 ppm of titanium, or from 0.5 to 14.0 ppm of titanium, or from 1.0 to 18.0 ppm of titanium, or from 1.0 to 16.0 ppm of titanium, or from 1.0 to 14.0 ppm of titanium, or from 2.0 to 18.0 ppm of titanium, or from 2.0 to 16.0 ppm of titanium, or from 2.0 to 14.0 ppm of titanium, or from 3.0 to 18.0 ppm of titanium, or from 3.0 to 16.0 ppm of titanium, or from 3.0 to 14.0 ppm of titanium. In some embodiments, the ethylene copolymer composition has from 0.50 to 14.0 ppm of titanium.

In some embodiments, the ethylene copolymer composition has a stress exponent, defined as Log₁₀[I₆/I₂]/Log₁₀[6.48/2.16], which is ≤1.70. In further embodiments, the ethylene copolymer composition has a stress exponent, Log₁₀[I₆/I₂]/Log₁₀[6.48/2.16], of less than 1.60, or less than 1.50, or less than 1.40, or less than 1.35.

In some embodiments, the ethylene copolymer composition has a dimensionless long chain branching factor, LCBF of >0.00001.

A monolayer film of the ethylene copolymer composition having a thickness of 89 μm can be used to measure hexane extractables, by the method described herein. As measured by this method, in some embodiments, the ethylene copolymer composition comprises hexane extractables of greater than 2%, or greater than 2.5%, or greater than 3%, or greater than 3.5%, or greater than 4%, or greater than 4.5%.

### Films and Manufactured Articles

The ethylene copolymer composition disclosed herein may be converted into flexible manufactured articles such as monolayer or multilayer films. Although films comprising the ethylene copolymer composition according to the first aspect of the invention are not known, related films and the concept thereof are well known to those experienced in the art. Non-limiting examples of process to prepare such films include blown film and cast film processes.

In the blown film extrusion process, an extruder heats, melts, mixes and conveys a thermoplastic, or a thermoplastic blend. Once molten, the thermoplastic is forced through an annular die to produce a thermoplastic tube. In the case of coextrusion, multiple extruders are employed to produce a multilayer thermoplastic tube. The temperature of the extrusion process is primarily determined by the thermoplastic or thermoplastic blend being processed, for example the melting temperature or glass transition temperature of the thermoplastic and the desired viscosity of the melt. In the case of polyolefins, typical extrusion temperatures are from 330° F. to 550° F. (166° C. to 288° C.). Upon exit from the annular die, the thermoplastic tube is inflated with air, cooled, solidified and pulled through a pair of nip rollers. Due to air inflation, the tube increases in diameter forming a bubble of desired size. Due to the pulling action of the nip rollers the bubble is stretched in the machine direction. Thus, the bubble is stretched in two directions: the transverse direction (TD) where the inflating air increases the diameter of the bubble; and the machine direction (MD) where the nip rollers stretch the bubble. As a result, the physical properties of blown films are typically anisotropic, i.e. the physical properties differ in the MD and TD directions; for example, film tear strength and tensile properties typically differ in the MD and TD. In some prior art documents, the terms “cross direction” or “CD” is used; these terms are equivalent to the terms “transverse direction” or “TD” used in this disclosure. In the blown film process, air is also blown on the external bubble circumference to cool the thermoplastic as it exits the annular die. The final width of the film is determined by controlling the inflating air or the internal bubble pressure; in other words, increasing or decreasing bubble diameter. Film thickness is controlled primarily by increasing or decreasing the speed of the nip rollers to control the draw-down rate. After exiting the nip rollers, the bubble or tube is collapsed and may be slit in the machine direction thus creating sheeting. Each sheet may be wound into a roll of film. Each roll may be further slit to create film of the desired width. Each roll of film is further processed into a variety of consumer products as described below.

The cast film process is similar in that a single or multiple extruder(s) may be used; however, the various thermoplastic materials are metered into a flat die and extruded into a monolayer or multilayer sheet, rather than a tube. In the cast film process, the extruded sheet is solidified on a chill roll.

In the cast film process, films are extruded from a flat die onto a chilled roll or a nipped roll, optionally, with a vacuum box and/or air-knife. The cast films may be monolayer or coextruded multi-layer films obtained by various extrusion through a single or multiple dies. The resultant films may be used as-is or may be laminated to other films or substrates, for example by thermal, adhesive lamination or direct extrusion onto a substrate. The resultant films and laminates may be subjected to other forming operations such as embossing, stretching, thermoforming. Surface treatments such as corona may be applied and the films may be printed.

In the cast film extrusion process, a thin film is extruded through a slit onto a chilled, highly polished turning roll, where it is quenched from one side. The speed of the roller controls the draw ratio and final film thickness. The film is then sent to a second roller for cooling on the other side. Finally, it passes through a system of rollers and is wound onto a roll.

In some embodiments, two or more thin films are coextruded through two or more slits onto a chilled, highly polished turning roll, the coextruded film is quenched from one side. The speed of the roller controls the draw ratio and final coextruded film thickness. The coextruded film is then sent to a second roller for cooling on the other side. Finally, it passes through a system of rollers and is wound onto a roll.

A cast film may further be laminated, one or more layers, into a multilayer structure.

Depending on the end-use application, the disclosed ethylene copolymer composition may be converted into films that span a wide range of thicknesses. Non-limiting examples include food packaging films, where thicknesses may range from about 0.5 mil (about 13 μm) to about 4 mil (about 102 μm), and heavy duty sack applications, where film thickness may range from about 2 mil (about 51 μm) to about 10 mil (about 254 μm).

The ethylene copolymer composition disclosed herein may be used in monolayer films; where the monolayer may contain more than one ethylene copolymer composition and/or additional thermoplastics; non-limiting examples of thermoplastics include polyethylene polymers (e.g. LLDPE) and propylene polymers. The lower limit on the weight percent of the ethylene copolymer composition in a monolayer film may be about 3 wt %, in other cases about 10 wt % and in still other cases about 30 wt %. The upper limit on the weight percent of the ethylene copolymer composition in the monolayer film may be 100 wt %, in other cases about 90 wt % and in still other cases about 70 wt %.

The ethylene copolymer composition disclosed herein may also be used in one or more layers of a multilayer film; non-limiting examples of multilayer films include two, three, four, five, six, seven, eight, nine or more layers. The thickness of a specific layer (containing the ethylene copolymer composition) within a multilayer film may be about 5% of the total multilayer film thickness, or about 10% or about 15% or about 20% or about 30% or about 45% or about 60% or about 75% or about 90% or about 95% of the total multilayer film thickness. Each individual layer of a multilayer film may contain more than one ethylene copolymer composition and/or additional thermoplastics (e.g. LLDPE).

Additional embodiments include laminations and coatings, wherein mono- or multilayer films containing the disclosed ethylene copolymer composition are extrusion laminated or adhesively laminated or extrusion coated. In extrusion lamination or adhesive lamination, two or more substrates are bonded together with a thermoplastic or an adhesive, respectively. In extrusion coating, a thermoplastic is applied to the surface of a substrate. These processes are well known to those experienced in the art. Frequently, adhesive lamination or extrusion lamination are used to bond dissimilar materials, non-limiting examples include the bonding of a paper web to a thermoplastic web, or the bonding of an aluminum foil containing web to a thermoplastic web, or the bonding of two thermoplastic webs that are chemically incompatible, e.g. the bonding of an ethylene copolymer composition containing web to a polyester or polyamide web. Prior to lamination, the web containing the disclosed ethylene copolymer composition(s) may be monolayer or multilayer. Prior to lamination, the individual webs may be surface treated to improve the bonding, a non-limiting example of a surface treatment is corona treating. A primary web or film may be laminated on its upper surface, its lower surface, or both its upper and lower surfaces with a secondary web. A secondary web and a tertiary web could be laminated to the primary web; wherein the secondary and tertiary webs differ in chemical composition. As non-limiting examples, secondary or tertiary webs may include: polyamide, polyester and polypropylene, or webs containing barrier resin layers such as EVOH. Such webs may also contain a vapor deposited barrier layer; for example, a thin silicon oxide (SiOₓ) or aluminum oxide (AlOₓ) layer. Multilayer webs (or films) may contain three, five, seven, nine, eleven or more layers.

The ethylene copolymer composition disclosed herein can be used in a wide range of manufactured articles comprising one or more films or film layers (monolayer or multilayer). Non-limiting examples of such manufactured articles include: food packaging films (fresh and frozen foods, liquids and granular foods), stand-up pouches, retortable packaging and bag-in-box packaging; barrier films (oxygen, moisture, aroma, oil, etc.) and modified atmosphere packaging; light and heavy duty shrink films and wraps, collation shrink film, pallet shrink film, shrink bags, shrink bundling and shrink shrouds; light and heavy duty stretch films, hand stretch wrap, machine stretch wrap and stretch hood films; high clarity films; heavy-duty sacks; household wrap, overwrap films and sandwich bags; industrial and institutional films, trash bags, can liners, magazine overwrap, newspaper bags, mail bags, sacks and envelopes, bubble wrap, carpet film, furniture bags, garment bags, coin bags, auto panel films; medical applications such as gowns, draping and surgical garb; construction films and sheeting, asphalt films, insulation bags, masking film, landscaping film and bags; geomembrane liners for municipal waste disposal and mining applications; batch inclusion bags; agricultural films, mulch film and green house films; in-store packaging, self-service bags, boutique bags, grocery bags, carry-out sacks and T-shirt bags; oriented films, machine direction and biaxially oriented films and functional film layers in oriented polypropylene (OPP) films, e.g. sealant and/or toughness layers. Additional manufactured articles comprising one or more films containing at least one ethylene copolymer composition include laminates and/or multilayer films; sealants and tie layers in multilayer films and composites; laminations with paper; aluminum foil laminates or laminates containing vacuum deposited aluminum; polyamide laminates; polyester laminates; extrusion coated laminates; and hot-melt adhesive formulations. The manufactured articles summarized in this paragraph contain at least one film (monolayer or multilayer) comprising at least one embodiment of the disclosed ethylene copolymer composition. The ethylene copolymer composition of the invention is particularly useful in cling or stretch or storage wrap films.

Cast films and laminates made from ethylene copolymer compositions of the present disclosure may be used in a variety of end-uses, such as for example, for food packaging (dry foods, fresh foods, frozen foods, liquids, processed foods, powders, granules), for packaging of detergents, toothpaste, towels, for labels and release liners. The cast films may also be used in unitization and industrial packaging, notably in stretch films. The cast films may also be suitable in hygiene and medical applications, for example in breathable and non-breathable films used in diapers, adult incontinence products, feminine hygiene products, ostomy bags. The ethylene copolymer composition of the present disclosure may also be useful in tapes and artificial turf applications.

Desired film physical properties (monolayer or multilayer) typically depend on the application of interest. Non-limiting examples of desirable film properties include: optical properties (gloss, haze and clarity), dart impact, Elmendorf tear, modulus (1% and 2% secant modulus), puncture-propagation tear resistance, tensile properties (yield strength, break strength, elongation at break, toughness, etc.) and heat sealing properties (heat seal initiation temperature and hot tack strength). Specific hot tack and heat sealing properties are desired in high speed vertical and horizontal form-fill-seal processes that load and seal a commercial product (liquid, solid, paste, part, etc.) inside a pouch-like package.

Where the application is cling or stretch or storage wrap films, particularly desired properties are good optical properties (generally high gloss and low haze, or a good balance thereof), good physical properties, good cling properties and good elongational properties.

In addition to desired film physical properties, it is desired that the disclosed ethylene copolymer composition is easy to process on film lines. Those skilled in the art frequently use the term “processability” to differentiate polymers with improved processability, relative to polymers with inferior processability. A commonly used measure to quantify processability is extrusion pressure; more specifically, a polymer with improved processability has a lower extrusion pressure (on a blown film or a cast film extrusion line) relative to a polymer with inferior processability.

The films used in the manufactured articles described in this section may optionally include, depending on its intended use, additives and adjuvants. Non-limiting examples of additives and adjuvants include anti-blocking agents, antioxidants, heat stabilizers, slip agents, processing aids, anti-static additives, colorants, dyes, filler materials, light stabilizers, light absorbers, lubricants, pigments, plasticizers, nucleating agents and combinations thereof.

In some embodiments, a film or film layer comprises the ethylene copolymer composition according to the first aspect.

In some embodiments, a film or film layer comprises a polyethylene blend comprising from 10 to 60 weight percent of the ethylene copolymer composition according to the first aspect and from 90 to 40 weight percent of a linear low density polyethylene (LLDPE).

In some embodiments, a film or film layer is a monolayer film and comprises the ethylene copolymer composition according to the first aspect.

In some embodiments, a film or film layer is a monolayer film and comprises a polyethylene blend comprising from 10 to 60 weight percent of the ethylene copolymer composition according to the first aspect and from 90 to 40 weight percent of a linear low density polyethylene (LLDPE).

In some embodiments, a film or film layer is a blown film.

In some embodiments, a film or film layer is a cast film.

In some embodiments, a film or film layer comprises the ethylene copolymer composition according to the first aspect and has a thickness of from 10 to 250 μm.

In some embodiments, a film or film layer comprises a polyethylene blend comprising from 10 to 60 weight percent of the ethylene copolymer composition according to the first aspect and from 90 to 40 weight percent of a linear low density polyethylene (LLDPE). and has a thickness of from 10 to 250 μm.

In some embodiments, a film or film layer has a thickness of from 10 to 250 μm.

The third aspect of the invention relates to a multilayer film structure comprising at least one film layer comprising the ethylene copolymer composition according to the first aspect.

The third aspect of the invention relates to a multilayer film structure comprising at least one film layer comprising a polyethylene blend comprising from 10 to 60 weight percent of the ethylene copolymer composition according to the first aspect and from 90 to 40 weight percent of a linear low density polyethylene (LLDPE).

In some embodiments, a multilayer film structure comprises at least one layer comprising the ethylene copolymer composition according to the first aspect, and the multilayer film structure has a thickness of from 10 to 250 μm.

In some embodiments, a multilayer film structure comprises at least one layer comprising a polyethylene blend comprising from 10 to 60 weight percent of the ethylene copolymer composition according to the first aspect and from 90 to 40 weight percent of a linear low density polyethylene (LLDPE). and the multilayer film structure has a thickness of from 10 to 250 μm.

An embodiment of the disclosure is a multilayer coextruded blown film structure.

An embodiment of the disclosure is a multilayer coextruded blown film structure having a thickness of from 10 to 250 μm.

An embodiment of the disclosure is a multilayer coextruded blown film structure comprising a film layer comprising the ethylene copolymer composition according to the first aspect.

An embodiment of the disclosure is a multilayer coextruded blown film structure comprising a film layer comprising a polyethylene blend comprising from 10 to 60 weight percent of the ethylene copolymer composition according to the first aspect and from 90 to 40 weight percent of a linear low density polyethylene (LLDPE).

An embodiment of the disclosure is a multilayer coextruded blown film structure comprising a film layer comprising the ethylene copolymer composition of the first aspect, and the multilayer film structure has a thickness of from 10 to 250 μm.

An embodiment of the disclosure is a multilayer coextruded blown film structure comprising a film layer comprising a polyethylene blend comprising from 10 to 60 weight percent of the ethylene copolymer composition according to the first aspect and from 90 to 40 weight percent of a linear low density polyethylene (LLDPE), and the multilayer film structure has a thickness of from 10 to 250 μm.

An embodiment of the disclosure is a multilayer coextruded cast film structure.

An embodiment of the disclosure is a multilayer coextruded cast film structure having a thickness of from 10 to 250 μm.

An embodiment of the disclosure is a multilayer coextruded cast film structure comprising a film layer comprising the ethylene copolymer composition according to the first aspect.

An embodiment of the disclosure is a multilayer coextruded cast film structure comprising a film layer comprising a polyethylene blend comprising from 10 to 60 weight percent of the ethylene copolymer composition according to the first aspect and from 90 to 40 weight percent of a linear low density polyethylene (LLDPE).

An embodiment of the disclosure is a multilayer coextruded cast film structure comprising a film layer comprising the ethylene copolymer composition of the first aspect, and the multilayer film structure has a thickness of from 10 to 250 μm.

An embodiment of the disclosure is a multilayer coextruded cast film structure comprising a film layer comprising a polyethylene blend comprising from 10 to 60 weight percent of the ethylene copolymer composition according to the first aspect and from 90 to 40 weight percent of a linear low density polyethylene (LLDPE), and the multilayer film structure has a thickness of from 10 to 250 μm.

An embodiment of the disclosure is a multilayer blown film structure comprising at least one blown film layer comprising the ethylene copolymer composition of the first aspect where the multilayer blown film structure has at least 2 layers, or at least 3 layers, or at least 4 layers, or at least 5 layers, or at least 6 layers, or at least 7 layers, or at least 8 layers, or at least 9 layers.

An embodiment of the disclosure is a multilayer blown film structure comprising at least one blown film layer comprising a polyethylene blend comprising from 10 to 60 weight percent of the ethylene copolymer composition according to the first aspect and from 90 to 40 weight percent of a linear low density polyethylene (LLDPE), where the multilayer blown film structure has at least 2 layers, or at least 3 layers, or at least 4 layers, or at least 5 layers, or at least 6 layers, or at least 7 layers, or at least 8 layers, or at least 9 layers.

An embodiment of the disclosure is a multilayer cast film structure comprising at least one cast film layer comprising the ethylene copolymer composition of the first aspect where the multilayer cast film structure has at least 2 layers, or at least 3 layers, or at least 4 layers, or at least 5 layers, or at least 6 layers, or at least 7 layers, or at least 8 layers, or at least 9 layers.

An embodiment of the disclosure is a multilayer cast film structure comprising at least one cast film layer comprising a polyethylene blend comprising from 10 to 60 weight percent of the ethylene copolymer composition according to the first aspect and from 90 to 40 weight percent of a linear low density polyethylene (LLDPE), where the multilayer cast film structure has at least 2 layers, or at least 3 layers, or at least 4 layers, or at least 5 layers, or at least 6 layers, or at least 7 layers, or at least 8 layers, or at least 9 layers.

An embodiment of the disclosure is a multilayer film structure comprising at least one film layer comprising the ethylene copolymer composition of the first aspect where the multilayer film structure has at least 2 layers, or at least 3 layers, or at least 4 layers, or at least 5 layers, or at least 6 layers, or at least 7 layers, or at least 8 layers, or at least 9 layers.

An embodiment of the disclosure is a multilayer film structure comprising at least one film layer comprising a polyethylene blend comprising from 10 to 60 weight percent of the ethylene copolymer composition according to the first aspect and from 90 to 40 weight percent of a linear low density polyethylene (LLDPE), where the multilayer film structure has at least 2 layers, or at least 3 layers, or at least 4 layers, or at least 5 layers, or at least 6 layers, or at least 7 layers, or at least 8 layers, or at least 9 layers.

An embodiment of the disclosure is a multilayer film structure comprising at least one film layer comprising the ethylene copolymer composition of the first aspect where the multilayer film structure has 9 layers.

An embodiment of the disclosure is a multilayer film structure comprising at least one film layer comprising a polyethylene blend comprising from 10 to 60 weight percent of the ethylene copolymer composition according to the first aspect and from 90 to 40 weight percent of a linear low density polyethylene (LLDPE), where the multilayer film structure has 9 layers.

An embodiment of the disclosure is a multilayer film structure comprising at least one cling layer comprising the ethylene copolymer composition of the first aspect.

An embodiment of the disclosure is a multilayer film structure comprising at least one cling layer comprising a polyethylene blend comprising from 10 to 60 weight percent of the ethylene copolymer composition according to the first aspect and from 90 to 40 weight percent of a linear low density polyethylene (LLDPE).

An embodiment of the disclosure is a multilayer film structure comprising a cling layer comprising the ethylene copolymer composition of the first aspect.

An embodiment of the disclosure is a multilayer film structure comprising a cling layer comprising a polyethylene blend comprising from 10 to 60 weight percent of the ethylene copolymer composition according to the first aspect and from 90 to 40 weight percent of a linear low density polyethylene (LLDPE). An embodiment of the disclosure is a multilayer film structure comprising a cling layer comprising the ethylene copolymer composition of the first aspect and where the multilayer film structure has at least 3 layers.

An embodiment of the disclosure is a multilayer film structure comprising a cling layer a polyethylene blend comprising from 10 to 60 weight percent of the ethylene copolymer composition according to the first aspect and from 90 to 40 weight percent of a linear low density polyethylene (LLDPE) and where the multilayer film structure has at least 3 layers.

An embodiment of the disclosure is a multilayer film structure comprising a cling layer comprising the ethylene copolymer composition of the first aspect and where the multilayer film structure has at least 5 layers.

An embodiment of the disclosure is a multilayer film structure comprising a cling layer comprising a polyethylene blend comprising from 10 to 60 weight percent of the ethylene copolymer composition according to the first aspect and from 90 to 40 weight percent of a linear low density polyethylene (LLDPE) and where the multilayer film structure has at least 5 layers.

An embodiment of the disclosure is a multilayer film structure comprising a cling layer comprising the ethylene copolymer composition of the first aspect and where the multilayer film structure has at least 7 layers.

An embodiment of the disclosure is a multilayer film structure comprising a cling layer comprising a polyethylene blend comprising from 10 to 60 weight percent of the ethylene copolymer composition according to the first aspect and from 90 to 40 weight percent of a linear low density polyethylene (LLDPE) and where the multilayer film structure has at least 7 layers.

An embodiment of the disclosure is a multilayer film structure comprising a cling layer comprising the ethylene copolymer composition of the first aspect and where the multilayer film structure has at least 9 layers.

An embodiment of the disclosure is a multilayer film structure comprising a cling layer comprising a polyethylene blend comprising from 10 to 60 weight percent of the ethylene copolymer composition according to the first aspect and from 90 to 40 weight percent of a linear low density polyethylene (LLDPE) and where the multilayer film structure has at least 9 layers.

An embodiment of the disclosure is a multilayer film structure comprising a cling layer comprising the ethylene copolymer composition of the first aspect and where the multilayer film structure has 9 layers.

An embodiment of the disclosure is a multilayer film structure comprising a cling layer comprising a polyethylene blend comprising from 10 to 60 weight percent of the ethylene copolymer composition according to the first aspect and from 90 to 40 weight percent of a linear low density polyethylene (LLDPE) and where the multilayer film structure has 9 layers.

Depending on the end-use application, the disclosed ethylene copolymer compositions or blend thereof with a linear low density polyethylene (LLDPE) may be converted into films that span a wide range of thicknesses. For example, the overall film thickness may be anywhere from 0.5 mil to 1.5 mil. In non-limiting embodiments, a cling layer may have a thickness in the range of from 0.1 to 0.6 mil, while a core layer may have a thickness in the range of from 0.9 mil to 1.4 mil.

### Core Layer(s)

In some embodiments, the multilayer film structure comprises a core layer, which may be between, for example sandwiched between, two skin layers. The multilayer film structure may comprise one, two, three, four, five, six, seven, eight, or nine core layers.

In embodiments, the core layer(s) may comprise a polyethylene copolymer such as linear low density polyethylene or medium density polyethylene or high density polyethylene or non-polyethylene materials such as nylon, ethylene vinyl alcohol, ethylene vinyl acetate, etc.

In embodiments, the core layer(s) may comprise the ethylene copolymer composition of the first aspect.

In embodiments, the core layer(s) may comprise a polyethylene blend comprising from 10 to 60 weight percent of the ethylene copolymer composition according to the first aspect and from 90 to 40 weight percent of a linear low density polyethylene (LLDPE).

In some embodiments, the core layer makes up at least 50 percent of the thickness of the multilayer film structure. In some embodiments, the core layer makes up at least 55 percent of the thickness of the multilayer film structure. In some embodiments, the core layer makes up at least 60 percent of the thickness of the multilayer film structure. In some embodiments, the core layer makes up at least 62 percent of the thickness of the multilayer film structure. In some embodiments, the core layer makes up at least 64 percent of the thickness of the multilayer film structure. In some embodiments, the core layer makes up at least 66 percent of the thickness of the multilayer film structure. In some embodiments, the core layer makes up at least 68 percent of the thickness of the multilayer film structure.

In some embodiments, the core layer makes up at most 85 percent of the thickness of the multilayer film structure. In some embodiments, the core layer makes up at most 80 percent of the thickness of the multilayer film structure. In some embodiments, the core layer makes up at most 78 percent of the thickness of the multilayer film structure. In some embodiments, the core layer makes up at most 76 percent of the thickness of the multilayer film structure. In some embodiments, the core layer makes up at most 74 percent of the thickness of the multilayer film structure. In some embodiments, the core layer makes up at most 72 percent of the thickness of the multilayer film structure.

In some embodiments, the core layer makes up between 50 and 85 percent of the thickness of the multilayer film structure. In some embodiments, the core layer makes up between 55 and 85 percent of the thickness of the multilayer film structure. In some embodiments, the core layer makes up between 50 and 80 percent of the thickness of the multilayer film structure. In some embodiments, the core layer makes up between 55 and 80 percent of the thickness of the multilayer film structure. In some embodiments, the core layer makes up between 50 and 76 percent of the thickness of the multilayer film structure. In some embodiments, the core layer makes up between 55 and 76 percent of the thickness of the multilayer film structure. In some embodiments, the core layer makes up between 60 and 80 percent of the thickness of the multilayer film structure. In some embodiments, the core layer makes up between 60 and 76 percent of the thickness of the multilayer film structure. In some embodiments, the core layer makes up between 64 and 76 percent of the thickness of the multilayer film structure. In some embodiments, the core layer makes up between 64 and 72 percent of the thickness of the multilayer film structure. In some embodiments, the core layer makes up between 68 and 76 percent of the thickness of the multilayer film structure. In some embodiments, the core layer makes up between 68 and 72 percent of the thickness of the multilayer film structure.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the words “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a”, “an”, and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about”, it will be understood that the particular value forms another embodiment. The term “about” in relation to a numerical value is optional and means, for example, +/−10%.

The following examples are presented for the purpose of illustrating selected embodiments of this disclosure; it being understood that the examples presented do not limit the claims presented.

### Examples

### General Testing Procedures

Prior to testing, each polymer specimen was conditioned for at least 24 hours at 23±2° C. and 50±10% relative humidity and subsequent testing was conducted at 23±2° C. and 50±10% relative humidity. Herein, the term “ASTM conditions” refers to a laboratory that is maintained at 23±2° C. and 50±10% relative humidity; and specimens to be tested were conditioned for at least 24 hours in this laboratory prior to testing. ASTM refers to the American Society for Testing and Materials.

### Density

Ethylene copolymer composition densities were determined using ASTM D792-13 (Nov. 1, 2013).

### Melt Index

Ethylene copolymer composition melt index was determined using ASTM D1238 (Aug. 1, 2013). Melt indexes, I₂, I₆, I₁₀ and I₂₁ were measured at 190° C., using weights of 2.16 kg, 6.48 kg, 10 kg and a 21.6 kg respectively. Herein, the term “stress exponent”, or its acronym “S.Ex.”, is defined by the following relationship: S.Ex.=log (I₆/I₂)/log(6480/2160) wherein 16 and 12 are the melt flow rates measured at 190° C. using 6.48 kg and 2.16 kg loads, respectively.

### Conventional Size Exclusion Chromatography (SEC)

Ethylene copolymer composition samples (polymer) solutions (1 to 3 mg/mL) were prepared by heating the polymer in 1,2,4-trichlorobenzene (TCB) and rotating on a wheel for 4 hours at 150° C. in an oven. An antioxidant (2,6-di-tert-butyl-4-methylphenol (BHT)) was added to the mixture in order to stabilize the polymer against oxidative degradation. The BHT concentration was 250 ppm. Polymer solutions were chromatographed at 140° C. on a PL 220 high-temperature chromatography unit equipped with four SHODEX® columns (HT803, HT804, HT805 and HT806) using TCB as the mobile phase with a flow rate of 1.0 mL/minute, with a differential refractive index (DRI) as the concentration detector. BHT was added to the mobile phase at a concentration of 250 ppm to protect GPC columns from oxidative degradation. The sample injection volume was 200 μL. The GPC columns were calibrated with narrow distribution polystyrene standards. The polystyrene molecular weights were converted to polyethylene molecular weights using the Mark-Houwink equation, as described in the ASTM standard test method D6474-12 (December 2012). The GPC raw data were processed with the CIRRUS© GPC software, to produce molar mass averages (Mₙ, M_{w}, M_{z}) and molar mass distribution (e.g. Polydispersity, M_{w}/Mₙ). In the polyethylene art, a commonly used term that is equivalent to SEC is GPC, i.e. Gel Permeation Chromatography.

### Triple Detection Size Exclusion Chromatography (3D-SEC)

Ethylene copolymer composition samples (polymer) solutions (1 to 3 mg/mL) were prepared by heating the polymer in 1,2,4-trichlorobenzene (TCB) and rotating on a wheel for 4 hours at 150° C. in an oven. An antioxidant (2,6-di-tert-butyl-4-methylphenol (BHT)) was added to the mixture in order to stabilize the polymer against oxidative degradation. The BHT concentration was 250 ppm. Sample solutions were chromatographed at 140° C. on a PL 220 high-temperature chromatography unit equipped with a differential refractive index (DRI) detector, a dual-angle light scattering detector (15 and 90 degree) and a differential viscometer. The SEC columns used were either four SHODEX columns (HT803, HT804, HT805 and HT806), or four PL Mixed ALS or BLS columns. TCB was the mobile phase with a flow rate of 1.0 mL/minute, BHT was added to the mobile phase at a concentration of 250 ppm to protect SEC columns from oxidative degradation. The sample injection volume was 200 μL. The SEC raw data were processed with the CIRRUS GPC software, to produce absolute molar masses and intrinsic viscosity ([η]). The term “absolute” molar mass was used to distinguish 3D-SEC determined absolute molar masses from the molar masses determined by conventional SEC. The viscosity average molar mass (Mv) determined by 3D-SEC was used in the calculations to determine the Long Chain Branching Factor (LCBF).

### GPC-FTIR

Ethylene copolymer composition (polymer) solutions (2 to 4 mg/mL) were prepared by heating the polymer in 1,2,4-trichlorobenzene (TCB) and rotating on a wheel for 4 hours at 150° C. in an oven. The antioxidant 2,6-di-tert-butyl-4-methylphenol (BHT) was added to the mixture in order to stabilize the polymer against oxidative degradation. The BHT concentration was 250 ppm. Sample solutions were chromatographed at 140° C. on a Waters GPC 150C chromatography unit equipped with four SHODEX columns (HT803, HT804, HT805 and HT806) using TCB as the mobile phase with a flow rate of 1.0 mL/minute, with a FTIR spectrometer and a heated FTIR flow through cell coupled with the chromatography unit through a heated transfer line as the detection system. BHT was added to the mobile phase at a concentration of 250 ppm to protect SEC columns from oxidative degradation. The sample injection volume was 300 μL. The raw FTIR spectra were processed with OPUS FTIR software and the polymer concentration and methyl content were calculated in real time with the Chemometric Software (PLS technique) associated with the OPUS. Then the polymer concentration and methyl content were acquired and baseline-corrected with the CIRRUS GPC software. The SEC columns were calibrated with narrow distribution polystyrene standards. The polystyrene molecular weights were converted to polyethylene molecular weights using the Mark-Houwink equation, as described in the ASTM standard test method D6474. The comonomer content was calculated based on the polymer concentration and methyl content predicted by the PLS technique as described in Paul J. DesLauriers, Polymer 43, pages 159-170 (2002); herein incorporated by reference.

The GPC-FTIR method measures total methyl content, which includes the methyl groups located at the ends of each macromolecular chain, i.e. methyl end groups. Thus, the raw GPC-FTIR data must be corrected by subtracting the contribution from methyl end groups. To be more clear, the raw GPC-FTIR data overestimates the amount of short chain branching (SCB) and this overestimation increases as molecular weight (M) decreases. In this disclosure, raw GPC-FTIR data was corrected using the 2-methyl correction. At a given molecular weight (M), the number of methyl end groups (NE) was calculated using the following equation; NE=28000/M, and NE (M dependent) was subtracted from the raw GPC-FTIR data to produce the SCB/1000C (2-Methyl Corrected) GPC-FTIR data.

### CRYSTAF/TREF (CTREF)

The “Composition Distribution Breadth Index”, hereinafter CDBI, of the ethylene copolymer compositions (and Comparative Examples) was measured using a CRYSTAF/TREF 200+ unit equipped with an IR detector, hereinafter the CTREF. The acronym “TREF” refers to Temperature Rising Elution Fractionation. The CTREF was supplied by Polymer Char S.A. (Valencia Technology Park, Gustave Eiffel, 8, Paterna, E-46980 Valencia, Spain). The CTREF was operated in the TREF mode, which generates the chemical composition of the polymer sample as a function of elution temperature, the Co/Ho ratio (Copolymer/Homopolymer ratio) and the CDBI (the Composition Distribution Breadth Index), i.e. CDBI₅₀ and CDBI₂₅.

A polymer sample (80 to 100 mg) was placed into the reactor vessel of the CTREF. The reactor vessel was filled with 35 ml of 1,2,4-trichlorobenzene (TCB) and the polymer was dissolved by heating the solution to 150° C. for 2 hours. An aliquot (1.5 mL) of the solution was then loaded into the CTREF column which was packed with stainless steel beads. The column, loaded with sample, was allowed to stabilize at 110° C. for 45 minutes. The polymer was then crystallized from solution, within the column, by dropping the temperature to 30° C. at a cooling rate of 0.09° C./minute. The column was then equilibrated for 30 minutes at 30° C. The crystallized polymer was then eluted from the column with TCB flowing through the column at 0.75 mL/minute, while the column was slowly heated from 30° C. to 120° C. at a heating rate of 0.25° C./minute. The raw CTREF data were processed using Polymer Char software, an Excel spreadsheet and CTREF software developed in-house.

CDBI₅₀ was defined as the weight percent of polymer whose composition is within 50% of the median comonomer composition; CDBI₅ was calculated from the composition distribution cure and the normalized cumulative integral of the composition distribution curve, as described in U.S. Pat. No. 5,376,439.

The CTREF procedures described here are also used to determine the weight percent (wt %) of the ethylene copolymer composition that elutes at a temperature below 30° C. and hereby referred to as “Soluble fraction (wt %) eluted below 30° C.”. Those skilled in the art will understand that a calibration curve is required to convert a CTREF elution temperature to comonomer content, i.e. the amount of comonomer in the ethylene/α-olefin polymer fraction that elutes at a specific temperature. The generation of such calibration curves are described in the prior art, e.g. Wild, et al., J. Polym. Sci., Part B, Polym. Phys., Vol. 20 (3), pages 441-455: hereby fully incorporated by reference. At the end of each sample run, the CTREF column was cleaned for 30 minutes; specifically, with the CTREF column at 160° C., TCB flowed (0.5 mL/minute) through the column for 30 minutes.

### Neutron Activation (Elemental Analysis)

Neutron Activation Analysis, hereinafter N.A.A., was used to determine catalyst metal residues in ethylene copolymer compositions as follows. A radiation vial (composed of ultrapure polyethylene, 7 mL internal volume) was filled with an ethylene copolymer composition sample and the sample weight was recorded. Using a pneumatic transfer system the sample was placed inside a SLOWPOKE™ nuclear reactor (Atomic Energy of Canada Limited, Ottawa, Ontario, Canada) and irradiated for 30 to 600 seconds for short half-life elements (e.g., Ti, V, Al, Mg, and Cl) or 3 to 5 hours for long half-life elements (e.g. Zr, Hf, Cr, Fe and Ni). The average thermal neutron flux within the reactor was 5×10¹¹/cm²/s. After irradiation, samples were withdrawn from the reactor and aged, allowing the radioactivity to decay; short half-life elements were aged for 300 seconds or long half-life elements were aged for several days. After aging, the gamma-ray spectrum of the sample was recorded using a germanium semiconductor gamma-ray detector (Ortec model GEM55185, Advanced Measurement Technology Inc., Oak Ridge, TN, USA) and a multichannel analyzer (Ortec model DSPEC Pro). The amount of each element in the sample was calculated from the gamma-ray spectrum and recorded in parts per million relative to the total weight of the ethylene copolymer composition sample. The N.A.A. system was calibrated with Specpure standards (1000 ppm solutions of the desired element (greater than 99% pure)). One mL of solutions (elements of interest) were pipetted onto a 15 mm×800 mm rectangular paper filter and air dried. The filter paper was then placed in a 1.4 mL polyethylene irradiation vial and analyzed by the N.A.A. system. Standards are used to determine the sensitivity of the N.A.A. procedure (in counts/μg).

### Unsaturation

The quantity of unsaturated groups, i.e. double bonds, in an ethylene copolymer composition was determined according to ASTM D3124-98 (vinylidene unsaturation, published March 2011) and ASTM D6248-98 (vinyl and trans unsaturation, published July 2012). An ethylene copolymer composition sample was: (a) first subjected to a carbon disulfide extraction to remove additives that may interfere with the analysis; (b) the sample (pellet, film or granular form) was pressed into a plaque of uniform thickness (0.5 mm); and (c) the plaque was analyzed by FTIR.

### Comonomer Content: Fourier Transform Infrared (FTIR) Spectroscopy

The quantity of comonomer in an ethylene copolymer composition was determined by FTIR and reported as the Short Chain Branching (SCB) content having dimensions of CH₃#/1000C (number of methyl branches per 1000 carbon atoms). This test was completed according to ASTM D6645-01 (2001), employing a compression molded polymer plaque and a Thermo-Nicolet 750 Magna-IR Spectrophotometer. The polymer plaque was prepared using a compression molding device (Wabash-Genesis Series press) according to ASTM D4703-16 (April 2016).

### ¹³C Nuclear Magnetic Resonance (NMR)

Between 0.21 and 0.30 g of polymer sample was weighed into 10 mm NMR tubes. The sample was then dissolved with deuterated ortho-dichlorobenzene (ODCB-d4) and heated to 125° C.; a heat gun was used to assist the mixing process. ¹³C NMR spectra (24000 scans per spectra) were collected on a Bruker AVANCE III HD 400 MHz NMR spectrometer fitted with a 10 mm PABBO probehead maintained at 125° C. Chemical shifts were referenced to the polymer backbone resonance, which was assigned a value of 30.0 ppm. ¹³C spectra were processed using exponential multiplication with a line broadening (LB) factor of 1.0 Hz. They were also processed using Gaussian multiplication with LB=−0.5 Hz and GB=0.2 to enhance resolution.

### Differential Scanning Calorimetry (DSC)

Primary melting peak (° C.), melting peak temperatures (° C.), heat of fusion (J/g) and crystallinity (%) were determined using differential scanning calorimetry (DSC) as follows: the instrument was first calibrated with indium; after the calibration, a polymer specimen was equilibrated at 0° C. and then the temperature was increased to 200° C. at a heating rate of 10° C./min; the melt was then kept isothermally at 200° C. for five minutes; the melt was then cooled to 0° C. at a cooling rate of 10° C./min and kept at 0° C. for five minutes; the specimen was then heated to 200° C. at a heating rate of 10° C./min. The DSC Tm, heat of fusion and crystallinity are reported from the 2^{nd} heating cycle.

### Dynamic Mechanical Analysis (DMA)

Oscillatory shear measurements under small strain amplitudes were carried out to obtain linear viscoelastic functions at 190° C. under N₂ atmosphere, at a strain amplitude of 10% and over a frequency range of 0.02-126 rad/s at 5 points per decade. Frequency sweep experiments were performed with a TA Instruments DHR3 stress-controlled rheometer using cone-plate geometry with a cone angle of 5°, a truncation of 137 μm and a diameter of 25 mm. In this experiment a sinusoidal strain wave was applied and the stress response was analyzed in terms of linear viscoelastic functions. The zero shear rate viscosity (η₀) based on the DMA frequency sweep results was predicted by Ellis model (see R. B. Bird et al. “Dynamics of Polymer Liquids. Volume 1: Fluid Mechanics” Wiley-Interscience Publications (1987) p. 228) or Carreau-Yasuda model (see K. Yasuda (1979) PhD Thesis, IT Cambridge). In this disclosure, the LCBF (Long Chain Branching Factor) was determined using the DMA determined η₀.

### Film Dart Impact

Film dart impact strength was determined using ASTM D1709-09 Method A (May 1, 2009). In this disclosure the dart impact test employed a 1.5 inch (38 mm) diameter hemispherical headed dart.

### Film Puncture

Film “puncture”, the energy (J/mm) required to break the film, was determined using ASTM D5748-95 (originally adopted in 1995, reapproved in 2012).

### Film Lubricated Puncture

The “lubricated puncture” test was performed as follows: the energy (J/mm) to puncture a film sample was determined using a 0.75-inch (1.9-cm) diameter pear-shaped fluorocarbon coated probe travelling at 10-inch per minute (25.4-cm/minute). ASTM conditions were employed. Prior to testing the specimens, the probe head was manually lubricated with Muko Lubricating Jelly to reduce friction. Muko Lubricating Jelly is a water-soluble personal lubricant available from Cardinal Health Inc., 1000 Tesma Way, Vaughan, ON L4K 5R₈ Canada. The probe was mounted in an Instron Model 5 SL Universal Testing Machine and a 1000-N load cell as used. Film samples (1.0 mil (25 μm) thick, 5.5 inch (14 cm) wide and 6 inch (15 cm) long) were mounted in the Instron and punctured.

### Film Tensile

The following film tensile properties were determined using ASTM D882-12 (Aug. 1, 2012): tensile break strength (MPa), elongation at break (%), tensile yield strength (MPa), tensile elongation at yield (%) and film toughness or total energy to break (ft·lb/in³). Tensile properties were measured in the both the machine direction (MD) and the transverse direction (TD) of the blown films.

### Film Secant Modulus

The secant modulus is a measure of film stiffness. The secant modulus is the slope of a line drawn between two points on the stress-strain curve, i.e. the secant line. The first point on the stress-strain curve is the origin, i.e. the point that corresponds to the origin (the point of zero percent strain and zero stress), and; the second point on the stress-strain curve is the point that corresponds to a strain of 1%; given these two points the 1% secant modulus is calculated and is expressed in terms of force per unit area (MPa). The 2% secant modulus is calculated similarly. This method is used to calculated film modulus because the stress-strain relationship of polyethylene does not follow Hook's law; i.e. the stress-strain behavior of polyethylene is non-linear due to its viscoelastic nature. Secant moduli were measured using a conventional Instron tensile tester equipped with a 200 lbf load cell. Strips of monolayer film samples were cut for testing with following dimensions: 14 inch long, 1 inch wide and 1 mil thick; ensuring that there were no nicks or cuts on the edges of the samples. Film samples were cut in both the machine direction (MD) and the transverse direction (TD) and tested. ASTM conditions were used to condition the samples. The thickness of each film was accurately measured with a hand-held micrometer and entered along with the sample name into the Instron software. Samples were loaded in the Instron with a grip separation of 10 inch and pulled at a rate of 1 inch/min generating the strain-strain curve. The 1% and 2% secant modulus were calculated using the Instron software.

### Film Elmendorf Tear

Film tear performance was determined by ASTM D1922-09 (May 1, 2009); an equivalent term for tear is “Elmendorf tear”. Film tear was measured in both the machine direction (MD) and the transverse direction (TD) of the blown films.

### Film Opticals

Film optical properties were measured as follows: Haze, ASTM D1003-13 (Nov. 15, 2013); and Gloss ASTM D2457-13 (Apr. 1, 2013).

### Film Dynatup Impact

Instrumented impact testing was carried out on a machine called a Dynatup Impact Tester purchased from Illinois Test Works Inc., Santa Barbara, CA, USA; those skilled in the art frequently call this test the Dynatup impact test. Testing was completed according to the following procedure. Test samples are prepared by cutting about 5 inch (12.7 cm) wide and about 6 inch (15.2 cm) long strips from a roll of blown film; film was about 1 mil thick. Prior to testing, the thickness of each sample was accurately measured with a handheld micrometer and recorded. ASTM conditions were employed. Test samples were mounted in the 9250 Dynatup Impact drop tower/test machine using the pneumatic clamp. Dynatup tup #1, 0.5 inch (1.3 cm) diameter, was attached to the crosshead using the Allen bolt supplied. Prior to testing, the crosshead is raised to a height such that the film impact velocity is 10.9±0.1 ft/s. A weight was added to the crosshead such that: 1) the crosshead slowdown, or tup slowdown, was no more than 20% from the beginning of the test to the point of peak load; and 2) the tup must penetrate through the specimen. If the tup does not penetrate through the film, additional weight is added to the crosshead to increase the striking velocity. During each test the Dynatup Impulse Data Acquisition System Software collected the experimental data (load (lb) versus time). At least 5 film samples are tested and the software reports the following average values: “Dynatup Maximum (Max) Load (lb)”, the highest load measured during the impact test; “Dynatup Total Energy (ft·lb)”, the area under the load curve from the start of the test to the end of the test (puncture of the sample); and “Dynatup Total Energy at Max Load (ft·lb)”, the area under the load curve from the start of the test to the maximum load point.

### Film Peel Cling

An internal peel cling procedure was used. This procedure is similar to ASTM D5458-95 (Dec. 1, 2020). It deviates from ASTM D5458-95 by applying pressure before removing the paper. While holding paper in place, a pressed finger is applied on it three times in the centre, three times on the left side, three times on the right and three times in the centre again.

### Film Hexane Extractables

Hexane extractables were determined according to the Code of Federal Registration 21 CFR § 177.1520 Para (c) 3.1 and 3.2; wherein the quantity of hexane extractable material in a film is determined gravimetrically. Elaborating, 2.5 grams of 3.5 mil (89 μm) compression molded plaque was placed in a stainless steel basket, the film and basket were weighed (wⁱ), while in the basket the film was: extracted with n-hexane at 49.5° C. for two hours; dried at 80° C. in a vacuum oven for 2 hours; cooled in a desiccator for 30 minutes; and weighed (w^{f}).

The percent loss in weight is the percent hexane extractables (w^{C6}): w^{C6}=100×(wⁱ−w^{f})/wⁱ.

### Long Chain Branching Factor (LCBF)

The LCBF (dimensionless) was determined for the ethylene copolymer composition using the method described in U.S. Pat. Appl. Pub. No. 2018/0305531 which is incorporated herein by reference.

### Ethylene Copolymer Compositions

Ethylene copolymer compositions were each made using a mixed dual catalyst system in an “in-series” dual reactor solution polymerization process. As a result, ethylene copolymer compositions each comprised a first ethylene copolymer made with a single site catalyst and a second ethylene copolymer made with a multi-site catalyst. An “in series” dual reactor, solution phase polymerization process, including one employing a mixed dual catalyst has been described in U.S. Pat. Appl. Pub. No. 2018/0305531. Basically, in an “in-series” dual reactor system the exit stream from a first polymerization reactor (R1) flows directly into a second polymerization reactor (R2).

The R1 pressure was from about 14 MPa to about 18 MPa; while R2 was operated at a lower pressure to facilitate continuous flow from R1 to R2. Both R1 and R2 were continuously stirred reactors (CSTRs) and were agitated to give conditions in which the reactor contents were well mixed. The process was operated continuously by feeding fresh process solvent, ethylene, 1-octene and hydrogen to the reactors and in the removal of product. Methylpentane was used as the process solvent (a commercial blend of methylpentane isomers). The volume of the first CSTR reactor (R1) was 3.2 gallons (12 L), and the volume of the second CSTR reactor (R2) was 5.8 gallons (22 L). Monomer (ethylene) and comonomer (1-octene) were purified prior to addition to the reactor using conventional feed preparation systems (such as contact with various absorption media to remove impurities such as water, oxygen and polar contaminants). The reactor feeds were pumped to the reactors at the ratios shown in Table 1. Average residence times for the reactors are calculated by dividing average flow rates by reactor volume and is primarily influenced by the amount of solvent flowing through each reactor and the total amount of solvent flowing through the solution process.

The following single site catalyst (SSC) components were used to prepare the first ethylene copolymer in a first reactor (R1) configured in series to a second reactor (R2): diphenylmethylene(cyclopentadienyl)(2,7-di-t-butylfuorenyl)hafnium dimethide [(2,7-tBu₂Flu)Ph₂C(Cp)HfMe₂]; methylaluminoxane (MMAO-07); trityl tetrakis(pentafluoro-phenyl)borate (trityl borate), and 2,6-di-tert-butyl-4-ethylphenol (BHEB). Methylaluminoxane (MMAO-07) and 2,6-di-tert-butyl-4-ethylphenol are premixed in-line and then combined with diphenylmethylene(cyclopentadienyl)(2,7-di-t-butylfuorenyl)hafnium dimethide and trityl tetrakis(pentafluoro-phenyl)borate just before entering the polymerization reactor (R1). The efficiency of the single site catalyst formulation was optimized by adjusting the mole ratios of the catalyst components and the R1 catalyst inlet temperature.

The following Ziegler-Natta (ZN) catalyst components were used to prepare the second ethylene copolymer in a second reactor (R2) configured in series to a first reactor (R1): butyl ethyl magnesium; tertiary butyl chloride; titanium tetrachloride; diethyl aluminum ethoxide; and triethyl aluminum. Methylpentane was used as the catalyst component solvent and the in-line Ziegler-Natta catalyst formulation was prepared using the following steps and then injected into the second reactor (R2). In step one, a solution of triethylaluminum and butyl ethyl magnesium (Mg:Al=20, mol:mol) was combined with a solution of tertiary butyl chloride and allowed to react for about 30 seconds to produce a MgCl₂ support. In step two, a solution of titanium tetrachloride was added to the mixture formed in step one and allowed to react for about 14 seconds prior to injection into second reactor (R2). The in-line Ziegler-Natta catalyst was activated in the reactor by injecting a solution of diethyl aluminum ethoxide into R2. The quantity of titanium tetrachloride added to the reactor is shown in Table 1. The efficiency of the in-line Ziegler-Natta catalyst formulation was optimized by adjusting the mole ratios of the catalyst components.

Polymerization in the continuous solution polymerization process was terminated by adding a catalyst deactivator to the second reactor exit stream. The catalyst deactivator used was octanoic acid (caprylic acid), commercially available from P&G Chemicals, Cincinnati, OH, U.S.A. The catalyst deactivator was added such that the moles of fatty acid added were 50% of the total molar amount of hafnium, titanium and aluminum added to the polymerization process; to be clear, the moles of octanoic acid added=0.5×(moles hafnium+moles titanium+moles aluminum).

A two-stage devolatilization process was employed to recover the ethylene copolymer composition from the process solvent, i.e. two vapor/liquid separators were used and the second bottom stream (from the second V/L separator) was passed through a gear pump/pelletizer combination. DHT-4V (hydrotalcite), supplied by Kyowa Chemical Industry Co. LTD, Tokyo, Japan was used as a passivator, or acid scavenger, in the continuous solution process. A slurry of DHT-4V in process solvent was added prior to the first V/L separator. The molar amount of DHT-4V added was 10-fold higher than the molar amount of tertiary butyl chloride and titanium tetrachloride added to the solution process.

Prior to pelletization the ethylene copolymer composition was stabilized by adding 500 ppm of IRGANOX® 1076 (a primary antioxidant) and 500 ppm of Irgafos 168 (a secondary antioxidant), based on weight of the ethylene copolymer composition. Antioxidants were dissolved in process solvent and added between the first and second V/L separators.

Table 1 shows the reactor conditions used to make each of the inventive ethylene copolymer compositions. Table 1 includes process parameters, such as the ethylene and 1-octene splits between the reactors (R1 and R2), the reactor temperatures, the ethylene conversions, etc.

The properties of inventive ethylene copolymer compositions (Inventive Examples 1 to 4), as well as those for several comparative resins (Comparative Examples 1 to 10) are shown in Table 2. Comparative Example 1 is QUEO® 0203, a resin commercially available from Borealis AG. Comparative Example 2 is EXCEED® 3812CB, a resin commercially available from ExxonMobil. Comparative Example 3 is FPS317, a resin commercially available from the NOVA Chemicals Corporation.

Comparative Example 4 is FPS417, a resin commercially available from the NOVA Chemicals Corporation. Comparative Example 5 is FG220, a resin commercially available from the NOVA Chemicals Corporation. Comparative Example 6 is an experimental grade made with combination of a single site catalyst which in known not to produce long chain branching in a first reactor and a Ziegler-Natta catalyst in a second reactor.

Comparative Example 7 is VPs412, a resin commercially available from the NOVA Chemicals Corporation. Comparative Example 8 is an experimental grade made with combination of a single site catalyst which in known not to produce long chain branching in a first reactor and a Ziegler-Natta catalyst in a second reactor. Comparative Example 9 is TF-0219, a resin commercially available from the NOVA Chemicals Corporation. Comparative Example 10 is PF-0218, a resin commercially available from the NOVA Chemicals Corporation. Comparative Example 11 is PF-0318, a resin commercially available from the NOVA Chemicals Corporation.

Inventive Examples 1 to 4 and Comparative Examples 1 and 3 to 8 are ethylene/1-octene copolymers. Comparative Examples 2 and 9 are ethylene/1-hexene copolymers. Comparative Examples 10 and 11 are ethylene/1-butene copolymers.

Details of the inventive ethylene copolymer composition components (the first ethylene copolymer and the second ethylene copolymer) are provided in Table 3.

The ethylene copolymer composition component properties shown in Table 3 were determined using a combination of CTREF analytical methods and calculations from a Polymerization Process Model (e.g. for the determination of SCB1, SCB2, d1 and d2 [also known as ρ¹ and ρ²], wt1 and wt2, Mw1, Mw2, Mn1, Mn2, I₂¹ and I₂²).

### Polymerization Process Model

For multicomponent (or bimodal resins) polyethylene polymers, the M_{w}, Mₙ, and M_{w}/Mₙ were calculated herein, by using a reactor model simulation using the input conditions which were employed for actual pilot scale run conditions (for references on relevant reactor modeling methods, see “Copolymerization” by A. Hamielec, J. MacGregor, and A. Penlidis in Comprehensive Polymer Science and Supplements, volume 3, Chapter 2, page 17, Elsevier, 1996 and “Copolymerization of Olefins in a Series of Continuous Stirred-Tank Slurry-Reactors using Heterogeneous Ziegler-Natta and Metallocene Catalysts. I. General Dynamic Mathematical Model” by J. B. P. Soares and A. E. Hamielec in Polymer Reaction Engineering, 4(2&3), p 153, 1996).

The model takes for input the flow of several reactive species (e.g. catalyst, monomer such as ethylene, comonomer such as 1-octene, hydrogen, and solvent) going to each reactor, the temperature (in each reactor), and the conversion of monomer (in each reactor), and calculates the polymer properties (of the polymer made in each reactor, i.e., the first and second ethylene copolymers) using a terminal kinetic model for continuously stirred tank reactors (CSTRs) connected in series. The “terminal kinetic model” assumes that the kinetics depend upon the monomer unit within the polymer chain on which the active catalyst site is located (see “Copolymerization” by A. Hamielec, J. MacGregor, and A. Penlidis in Comprehensive Polymer Science and Supplements, Volume 3, Chapter 2, page 17, Elsevier, 1996). In the model, the copolymer chains are assumed to be of reasonably large molecular weight to ensure that the statistics of monomer/comonomer unit insertion at the active catalyst center is valid and that monomers/comonomers consumed in routes other than propagation are negligible. This is known as the “long chain” approximation.

The terminal kinetic model for polymerization includes reaction rate equations for activation, initiation, propagation, chain transfer, and deactivation pathways. This model solves the steady-state conservation equations (e.g., the total mass balance and heat balance) for the reactive fluid which comprises the reactive species identified above.

The total mass balance for a generic CSTR with a given number of inlets and outlets is given by:

$$0 = {\sum }_{i} {\dot{m}}_{i} \qquad ( 1 )$$

where \dot{m}ᵢ represents the mass flow rate of individual streams with index i indicating the inlet and outlet streams.

Equation (1) can be further expanded to show the individual species and reactions:

$$0 = \frac{{\sum }_{i} m {\dot{x}}_{ι J} / {M}_{i}}{{ρ}_{miv} V} + {R}_{j} / {ρ}_{mix} \qquad ( 2 )$$

where Mᵢ is the average molar weight of the fluid inlet or outlet (i), xᵢⱼ is the mass fraction of species j in stream i, ρₘᵢₓ is the molar density of the reactor mixture, V is the reactor volume, Rⱼ is the reaction rate for species j, which has units of kmol/m³s.

The total heat balance is solved for an adiabatic reactor and is given by:

$$0 = ( \sum {\dot{m}}_{i} Δ {H}_{i} + {q}_{Rx} V + \dot{W} - \dot{Q} ) \qquad ( 3 )$$

where, \dot{m}ᵢ is the mass flow rate of stream i (inlet or outlet), ΔHᵢ is the difference in enthalpy of stream i versus a reference state, q_{Rx} is the heat released by reaction(s), Vis the reactor volume, \dot{W} is the work input (i.e., agitator), \dot{Q} is the heat input/loss.

The catalyst concentration input to each reactor is adjusted to match the experimentally determined ethylene conversion and reactor temperature values in order solve the equations of the kinetic model (e.g., propagation rates, heat balance and mass balance).

The H₂ concentration input to each reactor may be likewise adjusted so that the calculated molecular weight distribution of a polymer made over both reactors (and, hence, the molecular weight of polymer made in each reactor) matches that which is observed experimentally.

The weight fraction, wt1 and wt2 of material made in each reactor, R1 and R2, is determined from knowing the mass flow of monomer and comonomer into each reactor along with knowing the conversions for monomer and comonomer in each reactor calculated based on kinetic reactions.

The degree of polymerization (dpₙ) for a polymerization reaction is given by the ratio of the rate of chain propagation reactions over the rate of chain transfer/termination reactions:

$${dp}_{n} = \frac{{k}_{p 11} {ϕ}_{1} [ {m}_{1} ] + {k}_{p 12} {ϕ}_{1} [ {m}_{2} ] + {k}_{p 21} {ϕ}_{2} [ {m}_{2} ]}{\begin{matrix}{k}_{tm 11} [ {m}_{1} ] {ϕ}_{1} + {k}_{tm 12} [ {m}_{2} ] {ϕ}_{1} + {k}_{tm 21} [ {m}_{2} ] {ϕ}_{2} + \\ {k}_{ts 1} {ϕ}_{1} + {k}_{ts 2} {ϕ}_{2} + {k}_{tH 1} [ H ] + {k}_{tH 2} [ H ]\end{matrix}} = \frac{{R}_{p}}{{R}_{t}} \qquad ( 4 )$$

where kₚ₁₂ is the propagation rate constant for adding monomer 2 to a growing polymer chain ending with monomer 1, [m₁] is the molar concentration of monomer 1 (ethylene) in the reactor, [m₂] is the molar concentration of monomer 2 (1-octene) in the reactor, kₜₘ₁₂ the termination rate constant for chain transfer to monomer 2 for a growing chain ending with monomer 1, kₜₛ₁ is rate constant for the spontaneous chain termination for a chain ending with monomer 1, k_{tH1} is the rate constant for the chain termination by hydrogen for a chain ending with monomer 1. φ₁ and φ₂ and the fraction of catalyst sites occupied by a chain ending with monomer 1 or monomer 2 respectively.

The number average molecular weight (Mₙ) for a polymer follows from the degree of polymerization and the molecular weight of a monomer unit. From the number average molecular weight of polymer in a given reactor, and assuming a Flory-Schulz distribution for a single site catalyst, the molecular weight distribution is determined for the polymer using the following relationships.

$$w ( n ) = n {τ}^{2} {e}^{- τ n} \qquad ( 5 )$$

where n is the number of monomer units in a polymer chain, w(n) is the weight fraction of polymer chains having a chain length n, and 7 is calculated using the equation:

$$τ = \frac{1}{{dp}_{n}} = \frac{{R}_{t}}{{R}_{p}}$$

where dpₙ is the degree of polymerization, R_{P} is the rate of propagation and Rₜ is the rate of termination.

The Flory-Schulz distribution can be transformed into the common log scaled GPC trace by applying:

$$\frac{dW}{d log ( M )} = ln ( 10 ) \frac{{n}^{2}}{{dp}_{n} 2} {e}^{( - \frac{n}{{dp}_{n}} )} \qquad ( 6 )$$

where

$$\frac{dW}{d log ( MW )}$$

is the differential weight fraction of polymer with a chain length n (n=MW/28 where 28 is the molecular weight of the polymer segment corresponding to a C₂H₄ unit) and dpₙ is the degree of polymerization.

Assuming a Flory-Schultz model, different moments of molecular weight distribution can be calculated using the following;

$${μ}_{i} = {\int }_{0}^{∞} {n}^{i} W ( n ) dn$$

thus,
μ₀=1
μ₁=dpₙ, and
μ₂=2 dpₙ²;
   so,

$${M}_{n} = {Mw}_{monomer} \frac{{μ}_{1}}{{μ}_{0}} = {Mw}_{monomer} {dp}_{n}$$

$${M}_{w} = {Mw}_{monomer} \frac{{μ}_{2}}{{μ}_{1}} = 2 {Mw}_{monomer} {dp}_{n}$$

where Mwₘₒₙₒₘₑᵣ is the molecular weight of the polymer segment corresponding to a C₂H₄ unit of monomer.

Alternatively, when a Ziegler-Natta catalyst is employed, the molecular weight distribution of the polymer made in a given reactor by a Ziegler-Natta catalyst, can be modeled as above but using the sum of four such single site catalyst sites, each of which is assumed to have a Flory-Schultz distribution. When considering the kinetics of the process model for a Ziegler-Natta catalyst, the total amount of the Ziegler-Natta catalyst components fed to a reactor are known, and it is assumed that there is the same weight fraction of each of the four active catalyst sites modeled, but where each site has its own kinetics.

Finally, when a single site catalyst produces long chain branching, the molecular weight distribution is determined for the polymer using the following relationships (see “Polyolefins with Long Chain Branches Made with Single-Site Coordination Catalysts: A Review of Mathematical Modeling Techniques for Polymer Microstructure” by J. B. P. Soares in Macromolecular Materials and Engineering, volume 289, issue 1, pages 70-87, Wiley-VCH, 2004 and “Polyolefin Reaction Engineering” by J. B. P. Soares and T. F. L. McKenna, Wiley-VCH, 2012).

$$w ( n ) = \frac{( 1 - α ) {τ}_{B} {e}^{- {τ}_{B} n}}{( 1 + α )} {I}_{1} ( 2 \frac{{τ}_{B} n \sqrt{α}}{1 + α} )$$

where n is the number of monomer units in a polymer chain, w(n) is the weight fraction of polymer chains having a chain length n, and τ_{B} and α are calculated using equations below:

$${τ}_{B} = \frac{1}{{dp}_{n}^{B}} = \frac{{R}_{t} + {R}_{LCB}}{{R}_{p}}$$

$$α = \frac{{R}_{LCB}}{{R}_{p}}$$

where

$${dp}_{n}^{B}$$

is degree of polymerization, Rₚ is the rate propagation, Rₜ is the rate of termination and R_{LCB} is the rate of long chain branching formation calculated using equation below:

$${R}_{LCB} = {k}_{p 13} {ϕ}_{1} [ {m}_{3} ]$$

where kₚ₁₃ is the propagation rate constant for adding monomer 3 (macromonomer which is formed in the reactor) to a growing polymer chain ending with monomer 1, [m₃] is the molar concentration of macromonomer in the reactor.

The weight distribution can be transformed into the common log scaled GPC trace by applying:

$$\frac{dW}{d log ( M )} = ln ( 10 ) \frac{( 1 - α ) {τ}_{B} {e}^{- {τ}_{B} n}}{( 1 + α ) \sqrt{α}} {I}_{1} ( 2 \frac{{τ}_{B} n \sqrt{α}}{1 + α} ) \qquad ( 7 )$$

where

$$\frac{dW}{d log ( MW )}$$

is the differential weight fraction of polymer with a chain length n (n=MW/28 where 28 is the molecular weight of the polymer segment corresponding to a C₂H₄ unit).

From the weight distribution, different moments of molecular weight distribution can be calculated using the following:

$${M}_{n} = {Mw}_{monomer} {dp}_{n}^{B} \frac{1 + α}{1 - α}$$

$${M}_{w} = 2 {Mw}_{monomer} {dp}_{n}^{B} \frac{1 + α}{{( 1 - α )}^{2}}$$

where

$${dp}_{n}^{B}$$

is degree of polymerization, and a is calculated as above.

The short chain branch frequency of the second ethylene copolymer is calculated based on kinetic equations and co-monomer consumption using the following equation:

$$BF = \frac{{R}_{BF}}{{R}_{p}} = ( \frac{SCB 2}{1000 C} ) \qquad ( 8 )$$

where R_{BF} is the rate of short chain branching formation calculated using the equation:

$${R}_{BF} = {k}_{p 21} {ϕ}_{2} [ {m}_{1} ] + {k}_{p 22} {ϕ}_{2} [ {m}_{2} ] + {k}_{tm 12} {ϕ}_{1} [ {m}_{2} ] + {k}_{tm 22} {ϕ}_{2} [ {m}_{2} ]$$

The short chain branch frequency of the first ethylene copolymer is estimated using the following equation:

$${SCB}_{1} = ( SCB - {w}_{2} {SCB}_{2} ) / {w}_{1} \qquad ( 9 )$$

where the SCB₁, SCB₂ and SCB are the short chain branches per 1000 carbons of the first ethylene copolymer, the second ethylene copolymer (as determined above) and the overall experimentally determined short chain branching frequency for the polyethylene composition (i.e. as determined by FTIR analysis) respectively, and where w₁ and w₂ represent the respective weight fractions of the first and second ethylene copolymer components.

TABLE 1
Reactor Operating Conditions

| Example No. | Inv. 1 | Inv. 2 | Inv. 3 | Inv. 4 |
|---|---|---|---|---|
| Total Solution Rate [TSR] (kg/h) | 600.0 | 600.0 | 600.0 | 548.8 |
| Ethylene Concentration (wt % overall) | 15.0 | 13.0 | 14.1 | 13.3 |
| Ethylene Split Between Reactors | 24.0 | 20.0 | 25.0 | 25.0 |
| [R1/(R1 + R2)] | | | | |
| 1-Octene/ethylene (wt %) [total] | 0.275 | 0.690 | 0.654 | 0.670 |
| 1-Octene Split Between Reactors | 0.9498 | 0.2998 | 0.3503 | 0.4202 |
| [R1/(R1 + R2)] | | | | |
| Polymer Production Rate (kg/h) | 94.1 | 85.8 | 89.1 | 78.3 |
| [by near infrared] | | | | |
| Reactor 1 (R1) | | | | |
| Total Solution Rate in R1 (kg/h) | 201.4 | 141.0 | 191.1 | 170.6 |
| Ethylene Concentration (wt %) in R1 | 10.70 | 11.10 | 11.07 | 10.71 |
| 1-Octene/ethylene in Fresh Feed (g/g) | 1.19 | 1.13 | 1.00 | 1.23 |
| Primary Feed Inlet Temperature in R1 (° C.) | 30.0 | 33.7 | 35.0 | 35.0 |
| R1 Control Temperature (° C.) | 167.2 | 170.3 | 171.8 | 170.1 |
| Ethylene Conversion in R1 (%) | 86.05 | 85.04 | 85.10 | 85.03 |
| [by near infrared] | | | | |
| Hydrogen Feed (ppm) | 6.00 | 12.00 | 5.00 | 5.00 |
| Single Site Catalyst (ppm) to R1 | 0.96 | 0.59 | 0.65 | 0.64 |
| SSC - Al/Hf (mol/mol) | 30.0 | 30.1 | 30.0 | 30.0 |
| SSC - BHEB/Al (mol/mol) | 0.20 | 0.22 | 0.20 | 0.20 |
| SSC - B/Hf (mol/mol) | 1.20 | 1.20 | 1.20 | 1.20 |
| R1 Diluent Temperature (° C.) | 25.7 | 27.8 | 33.3 | 26.9 |
| Reactor 2 (R2) | | | | |
| Total Solution Rate in R2 (kg/h) | 398.6 | 458.9 | 408.9 | 378.3 |
| Ethylene Fresh Feed to R2 | 5.41 | 3.41 | 5.17 | 4.82 |
| Concentration (wt %) | | | | |
| 1-Octene/ethylene in Fresh Feed (g/g) | 0.02 | 0.66 | 0.62 | 0.56 |
| Primary Feed Temperature in R2 (° C.) | 35.0 | 35.0 | 40.1 | 40.0 |
| R2 Control Temperature (° C.) | 208.7 | 192.7 | 205.2 | 197.0 |
| Ethylene Conversion in R2 (%) | 86.43 | 87.25 | 85.59 | 85.56 |
| [by near infrared] | | | | |
| Hydrogen Feed (ppm) | 1.00 | 0.70 | 1.28 | 1.00 |
| Multi-site Catalyst (Ti ppm) to R2 | 6.20 | 4.82 | 5.78 | 3.92 |
| ZN - tert-butylchloride/Mg (mol/mol) | 1.98 | 1.98 | 2.10 | 2.10 |
| ZN - diethylaluminium ethoxide/Ti (mol/mol) | 1.35 | 1.35 | 1.35 | 1.34 |
| ZN - Mg/Ti (mol/mol) | 0.37 | 0.37 | 0.37 | 0.37 |
| R2 Diluent Temperature (° C.) | 30.5 | 31.6 | 35.8 | 30.7 |

TABLE 2
Properties of Ethylene Copolymer Compositions

| Example No. | Inv. 1 | Inv. 2 | Inv. 3 | Inv. 4 |
|---|---|---|---|---|
| Density (g/cm³) | 0.9157 | 0.9103 | 0.9090 | 0.9068 |
| Melt Index I₂ (g/10 min) | 4.03 | 3.14 | 3.92 | 3.85 |
| Melt Index I₂₁ (g/10 min) | 117.0 | 108.0 | 108.0 | 113.0 |
| Melt Flow Ratio (I₂₁/I₂) | 28.00 | 30.60 | 27.50 | 29.70 |
| Stress Exponent | 1.30 | 1.33 | 1.29 | 1.32 |
| Mₙ | 26590 | 24108 | 29272 | 22449 |
| M_{w} | 72026 | 85871 | 73727 | 77827 |
| M_{z} | 185443 | 336626 | 165648 | 219197 |
| Polydispersity Index (M_{w}/Mₙ) | 2.71 | 3.56 | 2.52 | 3.47 |
| CTREF - High Temperature Elution | 95.2 | 95.2 | 95.1 | 95.1 |
| Peak (° C.) | | | | |
| CTREF - CDBI₅₀ | 65.8 | 55.6 | 55.9 | 54.8 |
| CTREF - Soluble Fraction (wt %) | 29.9 | 25.8 | 27.4 | 32.5 |
| Eluted Below 30° C. | | | | |
| Co/Ho - Copolymer to Homopolymer Ratio | 0.7 | 5.5 | 5.4 | 4.5 |
| HD Fraction wt % | 58.3 | 15.4 | 15.6 | 18.1 |
| Heat of Fusion (J/g) | 127.7 | 109.5 | 105.7 | 96.3 |
| Crystallinity (%) | 44 | 38 | 37 | 33 |
| Branch Freq/1000 C | 20.7 | 23.1 | 22.2 | 25.3 |
| Comonomer | 1-octene | 1-octene | 1-octene | 1-octene |
| Comonomer Content (mole %) | 4.1 | 4.6 | 4.4 | 5.1 |
| Comonomer Content (wt. %) | 14.7 | 16.2 | 15.6 | 17.6 |
| Hexane Extractables (wt. %) | 11.81 | 4.71 | 2.52 | 8.22 |
| [Plaque, 89 μm] | | | | |
| LCBF | 0.00052 | 0.00003 | 0.00004 | 0.00045 |
| Internal Unsaturation/100 C | 0.006 | 0.008 | 0.008 | 0.008 |
| Side Chain Unsaturation/100 C | 0.009 | 0.009 | 0.012 | 0.013 |
| Terminal Unsaturation/100 C | 0.046 | 0.044 | 0.043 | 0.044 |

| Example No. | Comp. 1 | Comp. 2 | Comp. 3 | Comp. 4 | Comp. 5 |
|---|---|---|---|---|---|
| Density (g/cm³) | 0.9013 | 0.9113 | 0.9178 | 0.9176 | 0.9186 |
| Melt Index I₂ (g/10 min) | 3.23 | 3.78 | 3.72 | 4.09 | 2.26 |
| Melt Index I₂₁ (g/10 min) | 95.5 | 63.0 | 88.7 | 90.6 | 60.0 |
| Melt Flow Ratio (I₂₁/I₂) | 31.30 | 16.70 | 23.00 | 22.20 | 26.40 |
| Stress Exponent | 1.40 | 1.12 | 1.22 | 1.20 | 1.27 |
| Mₙ | 32204 | 42934 | 29718 | 27494 | 27189 |
| M_{w} | 68628 | 74382 | 74303 | 70855 | 84357 |
| M_{z} | 121272 | 114940 | 149726 | 138351 | 205976 |
| Polydispersity Index (M_{w}/Mₙ) | 2.13 | 1.73 | 2.5 | 2.58 | 3.1 |
| CTREF - High Temperature | 63.7 | 92.6 | 95.1 | 95.1 | 95.3 |
| Elution Peak (° C.) | | | | | |
| CTREF - CDBI₅₀ | 89.4 | 74.9 | 81.1 | 81 | 59.7 |
| CTREF - Soluble fraction (wt %) | 5.3 | 2.3 | 0.8 | 0.8 | 1.8 |
| Eluted Below 30° C. | | | | | |
| Co/Ho - Copolymer to | 0 | 64 | 17.9 | 18.3 | 7.4 |
| Homopolymer Ratio | | | | | |
| HD Fraction wt % | 0 | 1.5 | 5.3 | 5.2 | 11.9 |
| Heat of Fusion (J/g) | 86.1 | 111.4 | 124.7 | 127.7 | 135.7 |
| Crystallinity (%) | 30 | 38 | 43 | 44 | 47 |
| Branch Freq/1000 C | 24.6 | 18.9 | 14.5 | 14.4 | 13.8 |
| Comonomer | 1-octene | 1-hexene | 1-octene | 1-octene | 1-octene |
| Comonomer Content (mole %) | 4.9 | 3.8 | 2.9 | 2.9 | 2.8 |
| Comonomer Content (wt. %) | 17.2 | 10.6 | 10.7 | 10.6 | 10.2 |
| Hexane Extractables (wt. %) | 1.98 | 0.68 | 0.56 | 0.56 | 0.67 |
| [Plaque, 89 μm] | | | | | |
| Internal Unsaturation/100 C | 0.015 | 0.001 | 0.021 | 0.021 | 0.006 |
| Side Chain Unsaturation/100 C | 0.013 | 0.003 | 0.003 | 0.003 | 0.006 |
| Terminal Unsaturation/100 C | 0.012 | 0.007 | 0.006 | 0.006 | 0.050 |

| Example No. | Comp. 6 | Comp. 7 | Comp. 8 | Comp. 9 | Comp. 10 |
|---|---|---|---|---|---|
| Density (g/cm³) | 0.9104 | 0.9115 | 0.9151 | 0.9164 | 0.9236 |
| Melt Index I₂ (g/10 min) | 4.37 | 5.76 | 3.43 | 1.95 | 1.96 |
| Melt Index I₂₁ (g/10 min) | 98.0 | 82.0 | 66.0 | 54.7 | 49.3 |
| Melt Flow Ratio (I₂₁/I₂) | 21.80 | 21.32 | 19.70 | 28.10 | 25.20 |
| Stress Exponent | 1.21 | 1.20 | 1.18 | 1.29 | 1.26 |
| Mₙ | 29126 | 23931 | 31409 | 30208 | 33161 |
| M_{w} | 70512 | 67837 | 73369 | 90259 | 95513 |
| M_{z} | 142504 | 129321 | 135421 | 212599 | 250925 |
| Polydispersity Index (M_{w}/Mₙ) | 2.42 | 2.83 | 2.34 | 2.99 | 2.88 |
| CTREF - High Temperature | 95.7 | 96.2 | 95.4 | 95.9 | 94.8 |
| Elution Peak (° C.) | | | | | |
| CTREF - CDBI₅₀ | 65.7 | 68.3 | 68.7 | 32.7 | 48.1 |
| CTREF - Soluble Fraction | 1.6 | 5.8 | 4.1 | 13.7 | 9.2 |
| (wt %) Eluted Below 30° C. | | | | | |
| Co/Ho - Copolymer to | 11.3 | 13.5 | 12 | 2.2 | 4.5 |
| Homopolymer ratio | | | | | |
| HD Fraction wt % | 8.1 | 6.9 | 7.7 | 31.1 | 18.1 |
| Heat of Fusion (J/g) | 105.3 | 107.7 | 121.7 | 125.9 | 130.0 |
| Crystallinity (%) | 36 | 37 | 42 | 43 | 45 |
| Branch Freq/1000 C | 21.1 | 20 | 16.4 | 18.4 | 21.5 |
| Comonomer | 1-octene | 1-octene | 1-octene | 1-hexene | 1-butene |
| Comonomer Content (mole %) | 4.2 | 4 | 3.3 | 3.7 | 4.3 |
| Comonomer Content (wt %) | 15 | 14.3 | 11.9 | 10.3 | 8.2 |
| Hexane Extractables (%) | 1.72 | 1.35 | 0.52 | 1.96 | 0.86 |
| [Plaque, 89 μm] | | | | | |
| Internal Unsaturation/100 C | 0.011 | 0.01 | 0.009 | 0.001 | — |
| Side Chain | 0.005 | 0.004 | 0.004 | 0.004 | — |
| Unsaturation/100 C | | | | | |
| Terminal Unsaturation/100 C | 0.033 | 0.029 | 0.029 | 0.011 | — |

TABLE 3
Properties of Components of Ethylene Copolymer Compositions

| Example No. | Inv. 1 | Inv. 2 | Inv. 3 | Inv. 4 |
|---|---|---|---|---|
| The First Ethylene Copolymer | | | | |
| Catalyst Type 1 | Single site | Single site | Single site | Single site |
| | catalyst | catalyst | catalyst | catalyst |
| Weight Fraction [wt¹] (wt %) | 0.30 | 0.24 | 0.29 | 0.30 |
| I₂¹ (g/10 min) | 13.98 ^{c} | 20.69 ^{c} | 10.04 ^{c} | 13.11 ^{c} |
| ρ¹ (g/cm³) | 0.8734 ^{a} | 0.8784 ^{a} | 0.8837 ^{a} | 0.8778 ^{a} |
| Mn1 | 24212 | 21741 | 26487 | 24731 |
| Mw1 | 51008 | 45916 | 55742 | 51908 |
| Mw1/Mn1 | 2.11 | 2.11 | 2.10 | 2.10 |
| Short Chain Branches per 1000 | 56.26 | 49.29 | 42.32 | 50.15 |
| Carbons (SCB1) | | | | |
| The Second Ethylene Copolymer | | | | |
| Catalyst Type 2 | Ziegler- | Ziegler- | Ziegler- | Ziegler- |
| | Natta | Natta | Natta | Natta |
| | catalyst | catalyst | catalyst | catalyst |
| Weight Fraction [wt²] (wt %) | 0.70 | 0.76 | 0.71 | 0.70 |
| I₂² (g/10 min) | 4.37 ^{c} | 2.78 ^{c} | 4.60 ^{c} | 3.12 ^{c} |
| ρ² (g/cm³) | 0.9231 ^{b} | 0.9148 ^{b} | 0.9247 ^{b} | 0.9271 ^{b} |
| Mn2 | 21937 | 24480 | 21591 | 23177 |
| Mw2 | 73700 | 80663 | 70978 | 78731 |
| Mw2/Mn2 | 3.36 | 3.30 | 3.29 | 3.40 |
| Short Chain Branches per 1000 | 5.46 | 14.83 | 13.98 | 14.65 |
| Carbons (SCB2) | | | | |

^{a} ρ¹ = (−a₁ − (a₁² − 4*a₀*(a₂ − (SCB1C6/1000 C)))^{0.5}))/(2*a₀); where a₀ = 9341.81, a₁ = −17765.91 and a₂ = 8446.849.
^{b} ρ² = (ρ^{f} − wt¹*p¹)/(wt²); where ρ¹, ρ² and p^{f} are the densities of the first ethylene copolymer, the second ethylene copolymer and the overall (ethylene copolymer composition) density respectively, and wt¹ and wt² represent the respective weight fractions of the first and second ethylene copolymer components.
^{c} Melt Index (I₂, dg/min): Log I₂ = 7.8998042 − 3.9089344*log(Mw/1000) − 0.27994391*Mn/Mw; where Mw is weight average molecular weight of the respective component and Mn is number average molecular weight of the respective component (i.e. the first or the second ethylene copolymer) as determined by polymerization process modeling (see Polymerization Process Model section).

### Polymer Blends

Polymer blends can be prepared in numerous ways known in the art, including but not limited to melt compounding and solution blending. In the Examples described herein, blends using the inventive ethylene copolymer compositions with Comparative Example 11 were prepared by placing the target weight percentages of each resin (e.g. 80% and 50% by weight of Comparative Example 11, together with 20% and 50% by weight of either Inventive Example 1 or Inventive Example 3) into a batch mixer, and tumble blending for at least 15 minutes.

Blend 1 is 80/20 wt. % blend of Comparative Example 11 and Inventive Example 1. Blend 2 is 50/50 wt. % blend of Comparative Example 11 and Inventive Example 1. Blend 3 is 80/20 wt. % blend of Comparative Example 11 and Inventive Example 3. Blend 4 is 50/50 wt. % blend of Comparative Example 11 and Inventive Example 3.

Finished blends were fed directly into the extruder hopper as a dry blend to produce 1 mil films, as further described below.

### Cast Film (Monolayer)

Polymer blends made with the ethylene copolymer compositions of the present disclosure, or comparative Examples having similar density, were cast into monolayer film using a cast film line. The cast film line was a lab-scale measuring extruder that consisted of a coat hanger-style manifold die design with a nitrated steel surface finish. The die had a fixed lip gap of 0.5-millimeters and die gap width of 150-millimeters. Film was produced at a finished lay flat of 127-millimeters with a constant held output rate of 1.8 kg/hour to create a targeted 1 mil film thickness. The equipment specifications comprised of a bi-metallic lining one-piece extruder barrel, with a 4:1 length over diameter (L/D) compression ratio that was equipped with a three-stage pineapple mixer screw. The extruder was blower cooled and operated on a 3.75 horsepower motor, with a glycol cooled feed throat. The melted web was cast directly onto chrome-polished, water-chilled primary and secondary rolls with internal temperature control set at 23° C. Film travelled through a winder assembly and was collected on a surface drive roll that had tension control and winder torque adjustment capabilities. Table 4 lists the peel cling and other relevant film properties of comparative examples and blends of similar density made using the ethylene copolymer compositions of the present disclosure.

TABLE 4
Monolayer Film Properties

| | | Comp. | Comp. | Blend | Blend | Blend | Blend |
|---|---|---|---|---|---|---|---|
| Property | Unit | 3 | 11 | 1 | 2 | 3 | 4 |
| Overall Density | g/cc | 0.9178 | 0.9195 | 0.9188 | 0.9178 | 0.9174 | 0.9143 |
| Peel Cling | g | 101.6 | 109.5 | 143.1 | 154.7 | 124.6 | 135.9 |
| Gloss - 45 | | 92.3 | 93.0 | 91.9 | 89.1 | 92.6 | 92.3 |
| Haze | % | 1.26 | 2.78 | 2.51 | 2.44 | 2.21 | 1.92 |
| Puncture ASTM-Energy at Break | J/mm | 71.2 | 65.0 | 74.7 | 86.7 | 79.9 | 102.6 |
| (Avg) | | | | | | | |
| Puncture ASTM-Force-Max | lb | 5.9 | 6.0 | 5.7 | 6.0 | 5.9 | 6.0 |
| Puncture ASTM-Energy-Total | lbf-in | 15.4 | 14.1 | 14.7 | 17.0 | 15.7 | 18.1 |
| Puncture ASTM-Elongation- | in | 3.7 | 3.4 | 3.7 | 4.2 | 3.9 | 4.4 |
| Break | | | | | | | |
| Thickness | mil | 1.0 | 1.1 | 1.0 | 1.0 | 1.0 | 1.0 |
| Tensile, MD-Stress-Yield | MPa | 6.6 | 7.8 | 8.2 | 8.7 | 7.7 | 6.8 |
| Tensile, MD-Stress-Break | MPa | 37.9 | 37.5 | 33.4 | 35.4 | 38.2 | 36.9 |
| Tensile, MD-Energy-Tensile | J | 2.61 | 3.11 | 2.53 | 2.92 | 2.93 | 2.63 |
| Tensile, MD-Secant Modulus-1% | MPa | 95 | 129 | 134 | 155 | 119 | 101 |
| Tensile, MD-Secant Modulus-2% | MPa | 97 | 122 | 126 | 138 | 114 | 95 |
| Tensile, MD-Elongation-Yield | % | 15 | 14 | 16 | 15 | 15 | 15 |
| Tensile, TD-Elongation-Break | % | 504 | 540 | 525 | 579 | 552 | 531 |
| Tensile, TD-Stress-Yield | MPa | 6.2 | 7.4 | 7.7 | 8.1 | 7.1 | 6.5 |
| Tensile, TD-Stress-Break | MPa | 27.0 | 21.3 | 23.5 | 23.2 | 23.8 | 24.2 |
| Tensile, TD-Energy-Tensile | J | 2.83 | 3.29 | 3.28 | 3.20 | 3.23 | 2.81 |
| Tensile, TD-Secant Modulus-1% | MPa | 99 | 137 | 129 | 143 | 115 | 100 |
| Tensile, TD-Secant Modulus-2% | MPa | 96 | 124 | 121 | 127 | 105 | 94 |
| Tensile, TD-Elongation-Yield | % | 15 | 14 | 15 | 15 | 15 | 16 |
| Tensile, TD-Elongation-Break | % | 639 | 769 | 818 | 827 | 786 | 747 |

As shown by the data in Table 4, blends made using the inventive ethylene copolymer compositions show at least a 30% improvement in peel cling values over comparative examples even when the amount of inventive ethylene copolymer composition used in the blend was as low as 20% by weight. In addition, all other conventional film properties such as puncture resistance, tensile properties, and optical properties were on par or better than that of comparative examples. The data provided in Table 4 shows that when added to a LLDPE, the ethylene copolymer compositions of the present disclosure markedly improve the cling properties of the LLDPE when it is converted into film.

This invention provides ethylene-alpha-olefin copolymers with structural features that provide excellent cling for stretch-wrap applications. In particular, the invention relates to an adhesive cling layer in multilayer polymer films for cling/stretch-wrap applications.

Disclosed herein are the design criteria and means to produce such polymer compositions. The polymerization process disclosed herein uses a dual (or multi) reactor solution process with a homogeneous or heterogeneous catalyst formulation in the first reactor, a homogeneous or heterogeneous catalyst formulation in the second reactor, and an optional third reactor using a homogeneous or heterogeneous catalyst formulation, to produce ethylene-alpha-olefin copolymers with molecular characteristics suitable for the cling layer of cling/stretch-wrap applications.

More specifically, the design criteria to produce such polyethylene copolymers include a multicomponent solution reactor system, comprising a lower density ethylene plastomer or elastomer component with a lower M_{w} and higher melt index in the first reactor using a homogeneous or heterogeneous catalyst formulation, and a higher density plastomer, VLDPE, LLDPE or MDPE with a higher M_{w} and lower melt index in the second reactor using a homogeneous or heterogeneous catalyst formulation. The temperature of the second reactor is typically higher than that of the first reactor, and octene is not fed to the second reactor. The fact that there is a lower hydrogen feed to the second reactor than the first reactor helps to ensure that the second reactor produces an ethylene copolymer of higher M_{w}, despite the higher temperature.

Such novel ethylene copolymer compositions have high amounts of soluble weight fractions as measured using a slow CTREF technique (i.e. greater than 10%) and a high amount of hexane extractables as measured by the method described herein (i.e. greater than 2%).

The data in Table 2 shows that the Inventive Examples have a solution fraction in the CTREF analysis (the “CTREF-Soluble fraction (wt %) eluted below 30° C.”) which is greater than that observed for the Comparative Examples. The Inventive Examples also have a hexane extractables value (the “Hexane extractables (wt. %)”) which is much higher than those observed for the comparative resins (Comp. Examples 1-10).

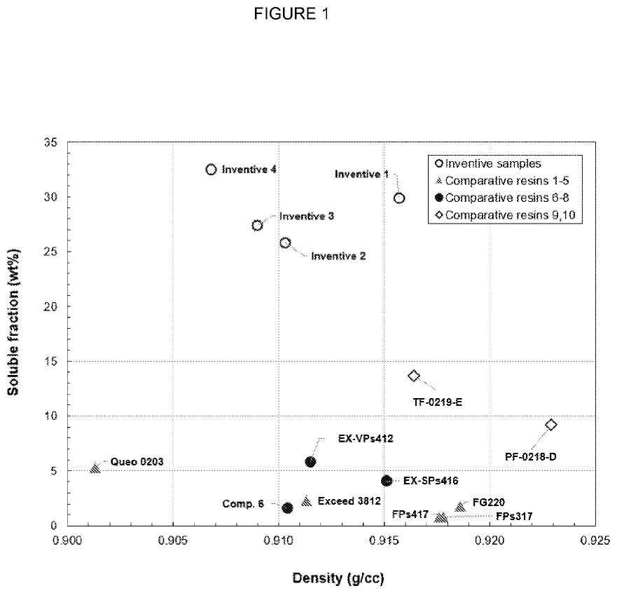

FIG. 1 shows a graph in which the density and the soluble fraction (wt %) eluted below 30° C. of the Inventive and Comparative Examples are plotted.

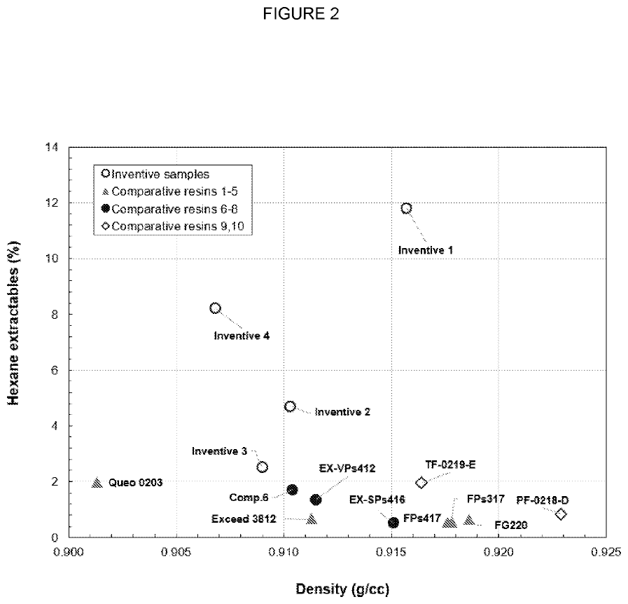

Meanwhile, FIG. 2 shows a graph in which the density and the hexane extractables percentage (as measured on plaques of 89 μm [3.5 mil]thickness by the method herein) are plotted for the Inventive and Comparative Examples.

In each of FIGS. 1 and 2, Inventive Examples 1 to 4 are shown by the unfilled circles, Comparative Examples 1 to 5 are shown by the triangles, Comparative Examples 6 to 8 are shown by the filled circles, and Comparative Examples 9 and 10 are shown by the diamonds.

As can be seen from FIG. 1, the Inventive Examples have soluble fractions that are significantly greater than the Comparative Examples, specifically greater than 10 wt % and more specifically greater than 25 wt %. Moreover, as shown in FIG. 2, the Inventive Examples have hexane extractables that are greater (and in some cases significantly greater) than the Comparative Examples, specifically greater than 2%.

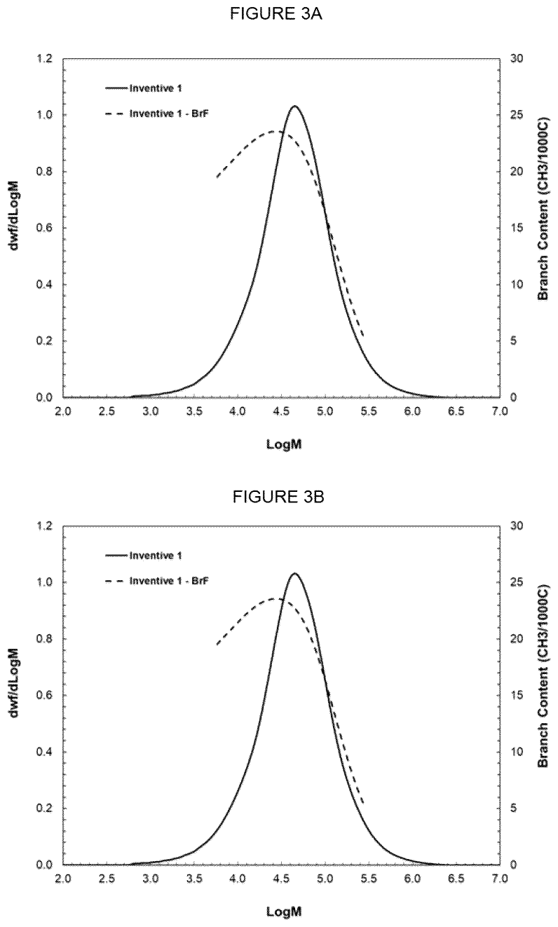

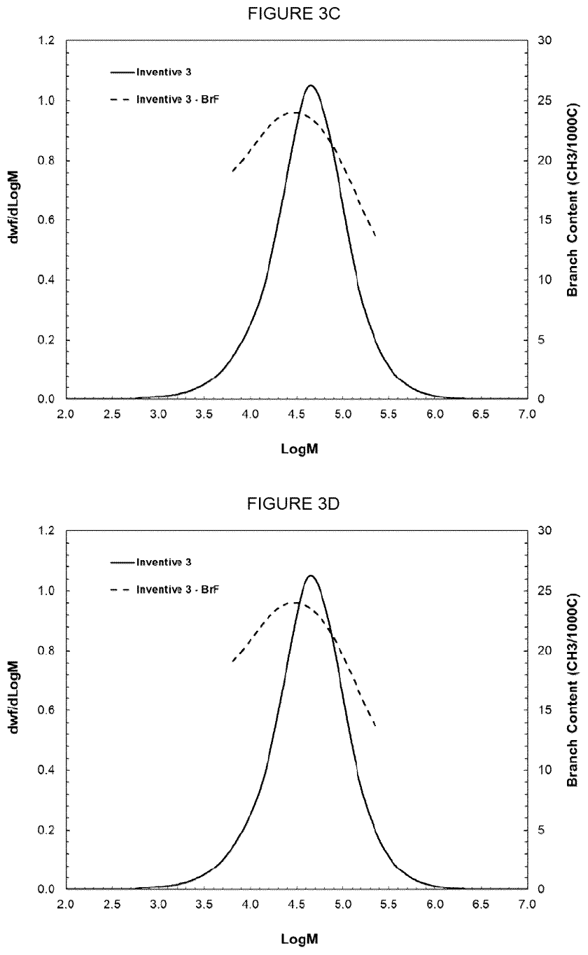

FIG. 3 shows GPC-FTIR molecular weight distribution and branch frequency distribution of Inventive Examples 1 to 4. Specifically, graph (a) shows Inventive Example 1, graph (b) shows Inventive Example 2, graph (c) shows Inventive Example 3, and graph (d) shows Inventive Example 4. Left side vertical axis represents weight fraction of the polymer and right side vertical axis represents number of short chain branches per 1000 carbons. The solid line represents molecular weight distribution and the dotted line represents short chain branching distribution across the molecular weight profile.

FIG. 3 shows that the inventive ethylene copolymer compositions have highly normal comonomer distribution, and that these compositions have highly branched, low molecular weight components, which contribute to enhanced adhesive or cling properties.

Having such highly branched, low molecular weight fractions in combination with less branched, high molecular weight fractions in a polymer composition helps to migrate the tacky (highly branched and low molecular weight) fractions to the surface of the film under high shear extrusion conditions to improve the cling properties of the films.

### INDUSTRIAL APPLICABILITY

Provided are ethylene copolymer compositions which are suitable for use in multilayer film structures. Such multilayer films structures may be useful for cling and stretch wrap film applications.

1. An ethylene copolymer composition comprising:
(i) from 2 to 45 weight percent of a first ethylene copolymer having a density of from 0.855 to 0.905 g/cm³, a molecular weight distribution (M_{w}/Mₙ) of from 1.8 to 3.0, and a melt index (I₂) of from 0.1 to 100 g/10 min;
(ii) from 55 to 98 weight percent of a second ethylene copolymer having a density of from 0.900 to 0.940 g/cm³, a molecular weight distribution (M_{w}/Mₙ) of from 1.8 to 4.0, and a melt index (I₂) of from 0.1 to 10 g/10 min; and
(iii) from 0 to 30 weight percent of a third ethylene copolymer having a density of from 0.900 to 0.940 g/cm³, a molecular weight distribution (M_{w}/Mₙ) of from 1.8 to 4.0, and a melt index (I₂) of from 0.1 to 10 g/10 min;
wherein the weight average molecular weight (M_{w}) of the second ethylene copolymer is greater than the M_{w} of the first ethylene copolymer, and the M_{w} of the third ethylene copolymer is greater than the M_{w} of the first ethylene copolymer;
the density of the second ethylene copolymer is greater than the density of the first ethylene copolymer, and the density of the third ethylene copolymer is greater than the density of the first ethylene copolymer; and
the ethylene copolymer composition has a density of from 0.900 to 0.925 g/cm³; a melt index of from 0.5 to 10 g/10 min; and a fraction eluting at below 30° C., having an integrated area of greater than 10% in a crystallizable temperature rising elution fractionation (CTREF) analysis;
wherein the weight percent of the first, second or third ethylene copolymer is defined as the weight of the first, second or third copolymer respectively divided by the weight of a sum of (i) The first ethylene copolymer, (ii) The second ethylene copolymer and (iii) The third ethylene copolymer, multiplied by 100.

2. The ethylene copolymer composition of claim 1, wherein the ethylene copolymer composition has a molecular weight distribution (M_{w}/Mₙ) of from 2.0 to 4.0.

3. The ethylene copolymer composition of claim 1, wherein the fraction eluting at below 30° C. has an integrated area of at least 20% in the CTREF analysis.

4. The ethylene copolymer composition of claim 1, wherein the ethylene copolymer composition comprises hexane extractables of greater than 2%, as measured from a compression molded plaque of the composition having a thickness of 89 μm.

5. The ethylene copolymer composition of claim 1, wherein the ethylene copolymer composition has a melt flow ratio (I₂₁/I₂) of from 22 to 60.

6. The ethylene copolymer composition of claim 1, wherein the first ethylene copolymer comprises from 10 to 45 weight percent of the ethylene copolymer composition.

7. The ethylene copolymer composition of claim 1, wherein the second ethylene copolymer comprises from 55 to 90 weight percent of the ethylene copolymer composition.

8. The ethylene copolymer composition of claim 1, wherein the third ethylene copolymer comprises 0 wt % of the ethylene copolymer composition.

9. The ethylene copolymer composition of claim 1, wherein the first ethylene copolymer comprises from 10 to 45 weight percent of the ethylene copolymer composition; the second ethylene copolymer comprises from 55 to 90 weight percent of the ethylene copolymer composition; and the third ethylene copolymer comprises 0 weight percent of the ethylene copolymer composition.

10. The ethylene copolymer composition of claim 1, wherein the third ethylene copolymer comprises from 5 to 30 weight percent of the ethylene copolymer composition.

11. The ethylene copolymer composition of claim 1, wherein the ethylene copolymer composition has a composition distribution breadth index (CDBI₅₀) of from 50 to 75 weight percent.

12-13. (canceled)

14. The ethylene copolymer composition of claim 1, wherein the ethylene copolymer composition comprises from about 3 to about 8 mole percent C₃ to C₁₀ alpha-olefin comonomer.

15. (canceled)

16. The ethylene copolymer composition of claim 1, wherein the ethylene copolymer composition comprises from about 5 to about 25 mole percent C₃ to C₁₀ alpha-olefin comonomer.

17. The ethylene copolymer composition of claim 16, wherein the alpha-olefin comonomer is selected from the group comprising: 1-hexene, 1-octene, and mixtures thereof.

18. The ethylene copolymer composition of claim 16, wherein the alpha-olefin comonomer consists of 1-octene.

19. The ethylene copolymer composition of claim 1, wherein the first ethylene copolymer has a density of from 0.865 to 0.905 g/cm³, optionally from 0.870 to 0.905 g/cm³.

20. The ethylene copolymer composition of claim 1, wherein the first ethylene copolymer has a melt index (I₂) of from 4 to 50 g/10 min.

21. The ethylene copolymer composition of claim 1, wherein the second ethylene copolymer has a density of from 0.910 to 0.940 g/cm³.

22. The ethylene copolymer composition of claim 1, wherein the second ethylene copolymer has a melt index (I₂) of from 0.2 to 6 g/10 min.

23-29. (canceled)

30. The ethylene copolymer composition of claim 1, wherein the number of short chain branches per thousand carbon atoms in the first ethylene copolymer (SCB1) is greater than the number of short chain branches per thousand carbon atoms in the second ethylene copolymer (SCB2).

31. The ethylene copolymer composition of claim 1, wherein the first ethylene copolymer has from 30 to 70 short chain branches per thousand carbon atoms (SCB1).

32. The ethylene copolymer composition of claim 1, wherein the second ethylene copolymer has from 3 to 25 short chain branches per thousand carbon atoms (SCB2).

33-34. (canceled)

35. The ethylene copolymer composition of claim 1, wherein the ethylene copolymer composition has a dimensionless long chain branching factor (LCBF) of at least 0.00001.

36. The ethylene copolymer composition of claim 1, wherein the ethylene copolymer composition has at least 0.0015 parts per million by weight (ppm) of hafnium.

37-38. (canceled)

39. A film layer comprising the ethylene copolymer composition of claim 1.

40. The film layer of claim 39, wherein the film layer is a blown film.

41. The film layer of claim 39, wherein the film layer is a cast film.

42. The film layer of claim 39, further comprising a linear low density polyethylene (LLDPE).

43. The film layer of claim 42, wherein the film layer comprises from 20 to 70 weight percent of the LLDPE and from 30 to 80 weight percent of the ethylene copolymer composition.

44. A multilayer film structure comprising at least one film layer of claim 39.

45. The multilayer film structure of claim 44, wherein the film structure comprises at least three layers.

46. The multilayer film structure of claim 44, wherein the film structure comprises between three and nine layers.

47. The multilayer film structure of claim 44 which is a skin layer.

48. The multilayer film structure of claim 44 comprising two film layers.

49. A cling wrap film comprising the multilayer film structure of claim 44.

50. A stretch wrap film comprising the multilayer film structure of claim 44.
